(19) United States
(12) Patent Application Publication
(10) Pub. No.: US 2024/0259153 A1
(43) Pub. Date: Aug. 1, 2024

(54) TERMINAL, BASE STATION AND METHOD PERFORMED BY THE SAME IN WIRELESS COMMUNICATION SYSTEM

(71) Applicant: SAMSUNG ELECTRONICS CO., LTD., Suwon-si, Gyeonggi-do (KR)

(72) Inventors: Di SU, Beijing (CN); Chen QIAN, Beijing (CN); Yi WANG, Beijing (CN); Sa ZHANG, Beijing (CN)

(21) Appl. No.: 18/566,593

(22) PCT Filed: Jun. 3, 2022
(86) PCT No.: PCT/KR2022/007955

§ 371 Date: Dec. 1, 2023

(30) Foreign Application Priority Data
Jun. 3, 2021 (CN) 202110619849.7

(51) Int. Cl. H04L 5/00; H04L 1/1812; H04W 72/0457

(52) U.S. Cl. CPC H04L 5/0048; H04L 1/1812; H04W 72/0457

(57) ABSTRACT

A terminal, a base station and a method performed by the same in a wireless communication system are provided. The method includes receiving one or more messages from abase station, where the one or more messages include first configuration information for configuring at least one first uplink bandwidth part (BWP) as an active uplink BWP and/or second configuration information for configuring at least one first downlink BWP as an active downlink BWP, and determining the active uplink BWP for an uplink transmission and/or the active downlink BWP for a downlink reception based on at least the first configuration information and/or the second configuration information. The invention can improve transmission quality and transmission rate of communication.

### TECHNICAL FIELD

The present disclosure generally relates to the field of wireless communication, and in particular, to a terminal, a base station and a method performed by the same in a wireless communication system.

### BACKGROUND ART

Considering the development of wireless communication from generation to generation, the technologies have been developed mainly for services targeting humans, such as voice calls, multimedia services, and data services. Following the commercialization of 5G (5th-generation) communication systems, it is expected that the number of connected devices will exponentially grow. Increasingly, these will be connected to communication networks. Examples of connected things may include vehicles, robots, drones, home appliances, displays, smart sensors connected to various infrastructures, construction machines, and factory equipment. Mobile devices are expected to evolve in various form-factors, such as augmented reality glasses, virtual reality headsets, and hologram devices. In order to provide various services by connecting hundreds of billions of devices and things in the 6G (6th-generation) era, there have been ongoing efforts to develop improved 6G communication systems. For these reasons, 6G communication systems are referred to as beyond-5G systems.

6G communication systems, which are expected to be commercialized around 2030, will have a peak data rate of tera (1,000 giga)-level bps and a radio latency less than 100 μsec, and thus will be 50 times as fast as 5G communication systems and have the 1/10 radio latency thereof.

In order to accomplish such a high data rate and an ultra-low latency, it has been considered to implement 6G communication systems in a terahertz band (for example, 95 GHz to 3 THz bands). It is expected that, due to severer path loss and atmospheric absorption in the terahertz bands than those in mmWave bands introduced in 5G, technologies capable of securing the signal transmission distance (that is, coverage) will become more crucial. It is necessary to develop, as major technologies for securing the coverage, radio frequency (RF) elements, antennas, novel waveforms having a better coverage than orthogonal frequency division multiplexing (OFDM), beamforming and massive multiple input multiple output (MIMO), full dimensional MIMO (FD-MIMO), array antennas, and multiantenna transmission technologies such as large-scale antennas. In addition, there has been ongoing discussion on new technologies for improving the coverage of terahertz-band signals, such as metamaterial-based lenses and antennas, orbital angular momentum (OAM), and reconfigurable intelligent surface (RIS).

Moreover, in order to improve the spectral efficiency and the overall network performances, the following technologies have been developed for 6G communication systems: a full-duplex technology for enabling an uplink transmission and a downlink transmission to simultaneously use the same frequency resource at the same time; a network technology for utilizing satellites, high-altitude platform stations (HAPS), and the like in an integrated manner; an improved network structure for supporting mobile base stations and the like and enabling network operation optimization and automation and the like; a dynamic spectrum sharing technology via collision avoidance based on a prediction of spectrum usage; an use of artificial intelligence (AI) in wireless communication for improvement of overall network operation by utilizing AI from a designing phase for developing 6G and internalizing end-to-end AI support functions; and a next-generation distributed computing technology for overcoming the limit of UE computing ability through reachable super-high-performance communication and computing resources (such as mobile edge computing (MEC), clouds, and the like) over the network. In addition, through designing new protocols to be used in 6G communication systems, developing mechanisms for implementing a hardware-based security environment and safe use of data, and developing technologies for maintaining privacy, attempts to strengthen the connectivity between devices, optimize the network, promote softwarization of network entities, and increase the openness of wireless communications are continuing.

It is expected that research and development of 6G communication systems in hyper-connectivity, including person to machine (P2M) as well as machine to machine (M2M), will allow the next hyper-connected experience. Particularly, it is expected that services such as truly immersive extended reality (XR), high-fidelity mobile hologram, and digital replica could be provided through 6G communication systems. In addition, services such as remote surgery for security and reliability enhancement, industrial automation, and emergency response will be provided through the 6G communication system such that the technologies could be applied in various fields such as industry, medical care, automobiles, and home appliances.

### DISCLOSURE OF INVENTION

### Technical Problem

The present disclosure provides method and apparatus for a MUSIM (multi-SIM) User Equipment's (UEs) in a wireless communication system.

### Solution to Problem

According to an aspect of an exemplary embodiment, there is provided a communication method in a wireless communication

### Advantageous Effects of Invention

Aspects of the present disclosure provide efficient communication methods in a wireless communication system.

### BRIEF DESCRIPTION OF DRAWINGS

In order to illustrate the technical schemes of the embodiments of the disclosure more clearly, the drawings of the embodiments of the disclosure will be briefly introduced below. Apparently, the drawings described below only refer to some embodiments of the disclosure, and do not limit the disclosure. In the drawings:

FIG. 1 illustrates a schematic diagram of an example wireless network according to some embodiments of the disclosure;

FIGS. 2A and 2B illustrate example wireless transmission and reception paths according to some embodiments of the disclosure;

FIG. 3A illustrates an example user equipment (UE) according to some embodiments of the disclosure;

FIG. 3B illustrates an example gNB according to some embodiments of the disclosure;

FIG. 4 is a schematic diagram of an example scenario in which three BWPs are configured;

FIG. 5 illustrates a schematic diagram of self-interference at a base station side when different BWPs in a single carrier have different uplink (UL)-downlink (DL) configurations in systems supporting flexible duplex;

FIGS. 6A and 6B illustrate flowcharts of methods performed by a terminal according to some embodiments of the disclosure;

FIGS. 7A and 7B illustrate flowcharts of methods performed by a terminal according to some embodiments of the disclosure;

FIGS. 8A and 8B illustrate flowcharts of methods performed by a terminal according to some embodiments of the disclosure;

FIG. 9 illustrates a flowchart of a method performed by a terminal according to some embodiments of the disclosure;

FIG. 10 illustrates a flowchart of a method performed by a base station according to some embodiments of the disclosure;

FIG. 11 illustrates a block diagram of a configuration of a terminal according to some embodiments of the disclosure; and

FIG. 12 illustrates a block diagram of a configuration of a base station according to some embodiments of the disclosure.

### BEST MODE FOR CARRYING OUT THE INVENTION

According to at least one embodiment of the disclosure, there is provided a method performed by a terminal in a wireless communication system. The method includes: receiving one or more messages from a base station, where the one or more messages include first configuration information for configuring at least one first uplink bandwidth part (BWP) as an active uplink BWP and/or second configuration information for configuring at least one first downlink BWP as an active downlink BWP; and determining the active uplink BWP for an uplink transmission and/or the active downlink BWP for a downlink reception based on at least the first configuration information and/or the second configuration information.

In some implementations, for example, the determining of the active uplink BWP for the uplink transmission and/or the active downlink BWP for the downlink reception includes: determining the at least one first uplink BWP as the active uplink BWP for the uplink transmission; and/or determining at least one second downlink BWP that is a current active downlink BWP as the active downlink BWP for the downlink reception. Each of the at least one first uplink BWP is different from each of the second downlink BWP.

In some implementations, for example, the determining of the active uplink BWP for the uplink transmission and/or the active downlink BWP for the downlink reception includes: determining the at least one first downlink BWP as the active downlink BWP for the downlink reception; and/or determining at least one second uplink BWP that is a current active uplink BWP as the active uplink BWP for the uplink transmission. Each of the at least one first downlink BWP is different from each of the at least one second uplink BWP.

In some implementations, for example, the determining of the active uplink BWP for the uplink transmission and/or the active downlink BWP for the downlink reception includes: determining all of the at least one first uplink BWP and at least one second uplink BWP that is a current active uplink BWP as the active uplink BWP for the uplink transmission; and/or determining all of the at least one first downlink BWP and at least one second downlink BWP that is a current active downlink BWP as the active downlink BWP for the downlink reception.

In some implementations, for example, the determining of the active uplink BWP for the uplink transmission and/or the active downlink BWP for the downlink reception includes: determining only the at least one first uplink BWP from among the at least one first uplink BWP and at least one second uplink BWP that is a current active uplink BWP as the active uplink BWP for the uplink transmission; and/or determining at least one second downlink BWP that is a current active downlink BWP as the active downlink BWP for the downlink reception. Each of the at least one first uplink BWP is different from each of the at least one second downlink BWP.

In some implementations, for example, the determining of the active uplink BWP for the uplink transmission and/or the active downlink BWP for the downlink reception includes: determining only at least one second uplink BWP that is a current active uplink BWP from among the at least one first uplink BWP and the at least one second uplink BWP as the active uplink BWP for the uplink transmission; and/or determining at least one second downlink BWP that is a current active downlink BWP as the active downlink BWP for the downlink reception. Each of the at least one second uplink BWP is different from each of the at least one second downlink BWP.

In some implementations, for example, the determining of the active uplink BWP for the uplink transmission and/or the active downlink BWP for the downlink reception includes: determining only the at least one first downlink BWP from among the at least one first downlink BWP and at least one second downlink BWP that is a current active downlink BWP as the active downlink BWP for the downlink reception; and/or determining at least one second uplink BWP that is a current active uplink BWP as the active uplink BWP for the uplink transmission. Each of the at least one first downlink BWP is different from each of the at least one second uplink BWP.

In some implementations, for example, the determining of the active uplink BWP for the uplink transmission and/or the active downlink BWP for the downlink reception includes: determining only at least one second downlink BWP that is a current active downlink BWP from among the at least one first downlink BWP and the at least one second downlink BWP as the active downlink BWP for the downlink reception; and/or determining at least one second uplink BWP that is a current active uplink BWP as the active uplink BWP for the uplink transmission. Each of the at least one second downlink BWP is different from each of the at least one second uplink BWP.

In some implementations, for example, the determining of the active uplink BWP for the uplink transmission and/or the active downlink BWP for the downlink reception includes: determining only the at least one first uplink BWP from among the at least one first uplink BWP and at least one second uplink BWP that is a current active uplink BWP to be used to transmit a first uplink signal, and determining only the at least one second uplink BWP from among the at least one first uplink BWP and the at least one second uplink BWP to be used to transmit a second uplink signal which is different from the first uplink signal. A time for transmitting the first uplink signal is different from a time for transmitting the second uplink signal.

In some implementations, for example, each of the first uplink signal and the second uplink signal includes one of: a Physical Uplink Shared Channel (PUSCH), a Physical Uplink Control Channel (PUCCH), or a Physical Random Access Channel (PRACH).

In some implementations, for example, the determining of the active uplink BWP for the uplink transmission and/or the active downlink BWP for the downlink reception includes: determining only the at least one first downlink BWP from among the at least one first downlink BWP and at least one second downlink BWP that is a current active downlink BWP to be used to receive a first downlink signal, and determining only the at least one second downlink BWP from among the at least one first downlink BWP and the at least one second downlink BWP to be used to receive a second downlink signal which is different from the first downlink signal. A time for receiving the first downlink signal is different from a time for receiving the second downlink signal.

In some implementations, for example, each of the first downlink signal and the second downlink signal includes one of: a Physical Downlink Shared Channel (PDSCH), a Physical Downlink Control Channel (PDCCH) of Common Search Space (CSS), a PDCCH of UE-specific Search Space (USS), a synchronization signal and physical broadcast channel block (SSB), or a system message block.

In some implementations, the method further includes: determining, when downlink reception is performed in the active downlink BWP, whether a time for the uplink transmission corresponding to the downlink reception is related to a predetermined time for a BWP change based on whether the active uplink BWP is the same as the active downlink BWP.

In some implementations, the method further includes: determining a time for feeding back Hybrid Automatic Repeat Request (HARQ) information of a Physical Downlink Shared Channel (PDSCH) based on whether the active uplink BWP is the same as the active downlink BWP, when the PDSCH is received in the active downlink BWP. For example, whether the time for feeding back the HARQ information of the PDSCH is related to the predetermined time for the BWP change may be determined based on whether the active uplink BWP is the same as the active downlink BWP.

In some implementations, the method further includes: determining, when a Physical Downlink Control Channel (PDCCH) is received in the active downlink BWP, whether the time for the uplink transmission is related to the predetermined time for the BWP change based on whether the active uplink BWP is the same as the active downlink BWP.

In some implementations, for example, a BWP change to the active downlink BWP is performed before the downlink reception is performed, when the active uplink BWP is different from the active downlink BWP and the uplink transmission is currently performed in the active uplink BWP.

In some implementations, for example, the uplink transmission and the downlink reception are not performed within the predetermined time for the BWP change.

In some implementations, for example, the predetermined time for the BWP change is determined based on a capability of the terminal. The capability of the terminal includes at least one of: a capability to support performing the uplink transmission on more than one BWP simultaneously; a capability to support performing the downlink reception on more than one BWP simultaneously; or a capability to support performing the uplink transmission and the downlink reception on different BWPs separately.

According to at least one embodiment of the disclosure, there is also provided a method performed by a base station in a wireless communication system. The method includes: transmitting one or more messages to a terminal, where the one or more messages include first configuration information for configuring at least one first uplink bandwidth part (BWP) as an active uplink BWP and/or second configuration information for configuring at least one first downlink BWP as an active downlink BWP; and determining the active uplink BWP for an uplink reception and/or the active downlink BWP for a downlink transmission based on at least the first configuration information and/or the second configuration information.

In some implementations, for example, the determining of the active uplink BWP for the uplink reception and/or the active downlink BWP for the downlink transmission includes: determining the at least one first uplink BWP as the active uplink BWP for the uplink reception; and/or determining at least one second downlink BWP that is a current active downlink BWP as the active downlink BWP for the downlink transmission. Each of the at least one first uplink BWP is different from each of the second downlink BWP.

In some implementations, for example, the determining of the active uplink BWP for the uplink reception and/or the active downlink BWP for the downlink transmission includes: determining the at least one first downlink BWP as the active downlink BWP for the downlink transmission; and/or determining at least one second uplink BWP that is a current active uplink BWP as the active uplink BWP for the uplink reception. Each of the at least one first downlink BWP is different from each of the at least one second uplink BWP.

In some implementations, for example, the determining of the active uplink BWP for the uplink reception and/or the active downlink BWP for the downlink transmission includes: determining all of the at least one first uplink BWP and at least one second uplink BWP that is a current active uplink BWP as the active uplink BWP for the uplink reception; and/or determining all of the at least one first downlink BWP and at least one second downlink BWP that is a current active downlink BWP as the active downlink BWP for the downlink transmission.

In some implementations, for example, the determining of the active uplink BWP for the uplink reception and/or the active downlink BWP for the downlink transmission includes: determining only the at least one first uplink BWP from among the at least one first uplink BWP and at least one second uplink BWP that is a current active uplink BWP as the active uplink BWP for the uplink reception; and/or determining at least one second downlink BWP that is a current active downlink BWP as the active downlink BWP for the downlink transmission. Each of the at least one first uplink BWP is different from each of the at least one second downlink BWP.

In some implementations, for example, the determining of the active uplink BWP for the uplink reception and/or the active downlink BWP for the downlink transmission includes: determining only at least one second uplink BWP that is a current active uplink BWP from among the at least one first uplink BWP and the at least one second uplink BWP as the active uplink BWP for the uplink reception; and/or determining at least one second downlink BWP that is a current active downlink BWP as the active downlink BWP for the downlink transmission. Each of the at least one second uplink BWP is different from each of the at least one second downlink BWP.

In some implementations, for example, the determining of the active uplink BWP for the uplink reception and/or the active downlink BWP for the downlink transmission includes: determining only the at least one first downlink BWP from among the at least one first downlink BWP and at least one second downlink BWP that is a current active downlink BWP as the active downlink BWP for the downlink transmission; and/or determining at least one second uplink BWP that is a current active uplink BWP as the active uplink BWP for the uplink reception. Each of the at least one first downlink BWP is different from each of the at least one second uplink BWP.

In some implementations, for example, the determining of the active uplink BWP for the uplink reception and/or the active downlink BWP for the downlink transmission includes: determining only at least one second downlink BWP that is a current active downlink BWP from among the at least one first downlink BWP and the at least one second downlink BWP as the active downlink BWP for the downlink transmission; and/or determining at least one second uplink BWP that is a current active uplink BWP as the active uplink BWP for the uplink reception. Each of the at least one second downlink BWP is different from each of the at least one second uplink BWP.

In some implementations, for example, the determining of the active uplink BWP for the uplink reception and/or the active downlink BWP for the downlink transmission includes: determining only the at least one first uplink BWP of the at least one first uplink BWP and at least one second uplink BWP that is a current active uplink BWP to be used to receive a first uplink signal, and determining only the at least one second uplink BWP of the at least one first uplink BWP and the at least one second uplink BWP to be used to receive a second uplink signal which is different from the first uplink signal. A time for receiving the first uplink signal is different from a time for receiving the second uplink signal.

In some implementations, for example, each of the first uplink signal and the second uplink signal includes one of: a Physical Uplink Shared Channel (PUSCH), a Physical Uplink Control Channel (PUCCH), or a Physical Random Access Channel (PRACH).

In some implementations, for example, the determining of the active uplink BWP for the uplink reception and/or the active downlink BWP for the downlink transmission includes: determining only the at least one first downlink BWP from among the at least one first downlink BWP and at least one second downlink BWP that is a current active downlink BWP to be used to transmit a first downlink signal, and determining only the at least one second downlink BWP from among the at least one first downlink BWP and the at least one second downlink BWP to be used to transmit a second downlink signal which is different from the first downlink signal. A time for transmitting the first downlink signal is different from a time for transmitting the second downlink signal.

In some implementations, for example, each of the first downlink signal and the second downlink signal includes one of: a Physical Downlink Shared Channel (PDSCH), a Physical Downlink Control Channel (PDCCH) of Common Search Space (CSS), a PDCCH of UE-specific Search Space (USS), a synchronization signal and physical broadcast channel block (SSB), or a system message block.

In some implementations, the method further includes: determining, when downlink transmission is performed in the active downlink BWP, whether a time for the uplink reception corresponding to the downlink transmission is related to a predetermined time for a BWP change based on whether the active uplink BWP is the same as the active downlink BWP.

In some implementations, for example, when the downlink reception is for a Physical Downlink Shared Channel (PDSCH), the uplink transmission corresponding to the downlink reception is used to feed back Hybrid Automatic Repeat Request (HARQ) information of the PDSCH.

In some implementations, for example, when the received downlink reception is for a Physical Downlink Control Channel (PDCCH), the uplink transmission corresponding to the downlink reception is for a physical channel (e.g., PUCCH or PUSCH) scheduled by the PDCCH.

In some implementations, for example, when a Physical Downlink Shared Channel (PDSCH) is transmitted in the active downlink BWP, a time for receiving Hybrid Automatic Repeat Request (HARQ) information of the PDSCH is determined based on whether the active uplink BWP is the same as the active downlink BWP. For example, whether the time for receiving the HARQ information of the PDSCH is related to the predetermined time for the BWP change may be determined based on whether the active uplink BWP is the same as the active downlink BWP.

In some implementations, the method further includes: determining, when a Physical Downlink Control Channel (PDCCH) is transmitted in the active downlink BWP, a time for the uplink reception based on whether the active uplink BWP is the same as the active downlink BWP. For example, whether the time for the uplink reception is related to the predetermined time for the BWP change may be determined based on whether the active uplink BWP is the same as the active downlink BWP.

In some implementations, for example, a BWP change to the active downlink BWP is performed before the downlink transmission is performed, when the active uplink BWP is different from the active downlink BWP and the uplink reception is currently performed in the active uplink BWP.

In some implementations, for example, the uplink reception and the downlink transmission are not performed within the predetermined time for the BWP change; and/or the uplink transmission and the downlink reception of the terminal and/or other terminals within the predetermined time for the BWP change are not configured; and/or the terminal and/or other terminals are configured such that uplink transmission and the downlink reception are not performed within the predetermined time for the BWP change.

In some implementations, for example, the predetermined time for the BWP change is determined based on a capability of the terminal reported by the terminal. The capability of the terminal includes at least one of: a capability to support performing the uplink transmission on more than one BWP simultaneously; a capability to support performing the downlink reception on more than one BWP simultaneously; or a capability to support performing the uplink transmission and the downlink reception on different BWPs separately.

According to at least one embodiment of the disclosure, there is also provided a terminal in a wireless communication system. The terminal includes a transceiver configured to transmit and receive signals, and a controller coupled with the transceiver and configured to perform one or more operations in the method performed by the terminal described above.

According to at least one embodiment of the disclosure, there is also provided a base station in a wireless communication system. The base station includes a transceiver configured to transmit and receive signals, and a controller coupled with the transceiver and configured to perform one or more operations in the method performed by the base station described above.

According to some embodiments of the disclosure, there is also provided a computer-readable storage medium having one or more computer programs stored thereon, where the one or more computer programs, when executed by one or more processors, can implement any of the methods described above.

### MODE FOR THE INVENTION

The following description with reference to the accompanying drawings is provided to facilitate a comprehensive understanding of various embodiments of the disclosure defined by the claims and their equivalents. The description includes various specific details to facilitate understanding but should only be considered as exemplary. Therefore, those of ordinary skill in the art will recognize that various changes and modifications can be made to the various embodiments described herein without departing from the scope and spirit of the disclosure. In addition, for the sake of clarity and simplicity, the description of well-known functions and structures may be omitted.

The terms and expressions used in the following description and claims are not limited to their dictionary meanings, but only used by the inventors to enable a clear and consistent understanding of the disclosure. Therefore, it should be obvious to those skilled in the art that the following description of various embodiments of the disclosure is provided for the purpose of illustration only, but not the purpose of limitation of the disclosure as defined by the appended claims and their equivalents.

It should be understood that singular forms of “a”, “an” and “the” include plural references, unless the context clearly indicates otherwise. Therefore, for example, a reference to “a component surface” include referring to one or more such surfaces.

The term “include” or “may include” refers to the existence of corresponding disclosed functions, operations or components that may be used in various embodiments of the disclosure, rather than limiting the existence of one or more additional functions, operations or features. In addition, the term “include” or “have” may be interpreted to indicate certain characteristics, numbers, steps, operations, constituent elements, components or combinations thereof, but should not be interpreted to exclude the possibility of the existence of one or more other characteristics, numbers, steps, operations, constituent elements, components or combinations thereof.

The term “or” used in various embodiments of the disclosure includes any listed terms and all combinations thereof. For example, “A or B” may include A, B, or both A and B.

It should be understood that the “first”, “second” and similar words used in the disclosure do not indicate any order, quantity or importance, but are only used to distinguish different constituent parts.

When used with a list of items, the phrase “at least one of . . . ” means that different combinations of one or more listed items may be used, and only one item in the list may be needed. For example, “at least one of A, B and C” includes any one of the following combinations: A, B, C, A and B, A and C, B and C, and A and B and C. For example, “at least one of A, B or C” includes any of the following combinations: A, B, C, A and B, A and C, B and C, and A and B and C.

The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The phrase “associated with,” as well as derivatives thereof, means to include, be included within, connect to, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller can be implemented in hardware or a combination of hardware and software and/or firmware. The functionality associated with any particular controller can be centralized or distributed, whether locally or remotely.

As used herein, any reference to “one example” or “example”, “one implementation” or “implementation”, and “one embodiment” or “embodiment” means that particular elements, features, structures or characteristics described in combination with the embodiment is included in at least one embodiment. The phrases “in one embodiment” or “in one example” appearing in different places in the specification do not necessarily refer to the same embodiment.

Unless defined differently, all terms (including technical terms or scientific terms) used in the disclosure have the same meaning as those described in the disclosure and understood by those skilled in the art. Common terms as defined in dictionaries are interpreted to have meanings consistent with the context in the related technical field, and should not be interpreted in an idealized or overly formal way unless explicitly so defined in the disclosure.

Moreover, various functions described below can be implemented or supported by one or more computer programs, each of which is formed from computer-readable program code and embodied in a computer-readable medium. The terms “application” and “program” refer to one or more computer programs, software components, sets of instructions, procedures, functions, objects, classes, instances, related data, or a portion thereof adapted for implementation in a suitable computer-readable program code. The phrase “computer-readable program code” includes any type of computer code, including source code, object code, and executable code. The phrase “computer-readable medium” includes any type of medium capable of being accessed by a computer, such as Read-Only Memory (ROM), Random Access Memory (RAM), a hard disk drive, a Compact Disc (CD), a Digital Video Disc (DVD), or any other type of memory. A “non-transitory” computer-readable medium excludes wired, wireless, optical, or other communication links that transport transitory electrical or other signals. A non-transitory computer-readable medium includes media where data can be permanently stored and media where data can be stored and later overwritten, such as a rewritable optical disc or an erasable memory device.

The various embodiments discussed below for describing the principles of the disclosure in the patent document are for illustration only and should not be interpreted as limiting the scope of the disclosure in any way. Those skilled in the art will understand that the principles of the disclosure can be implemented in any suitably arranged wireless communication system. For example, although the following detailed description of the embodiments of the disclosure will be directed to LTE and/or 5G, those skilled in the art can understand that the main points of the disclosure can also be applied to other communication systems with similar technical backgrounds and channel formats with slight modifications without departing from the scope of the disclosure. For example, the technical schemes of the embodiments of the present application can be applied to various communication systems. For example, the communication systems may include a global system for mobile communications (GSM) system, a code division multiple access (CDMA) system, a wideband code division multiple access (WCDMA) system, a general packet radio service (GPRS), a long term evolution (LTE) system, a LTE frequency division duplex (FDD) system, a LTE time division duplex (TDD), a universal mobile telecommunications system (UMTS), a worldwide interoperability for microwave access (WiMAX) communication system, a 5th generation (5G) system or new radio (NR), etc. In addition, the technical schemes of the embodiments of the present application can be applied to future-oriented communication technologies.

In the description of the disclosure, when it is considered that some detailed explanations about functions or configurations may unnecessarily obscure the essence of the disclosure, these detailed explanations will be omitted. All terms (including descriptive or technical terms) used herein should be interpreted as having apparent meanings to those of ordinary skill in the art. However, these terms may have different meanings according to the intention of those of ordinary skill in the art, precedents or the emergence of new technologies, and therefore, the terms used herein must be defined based on the meanings of these terms together with the description throughout the specification. Hereinafter, for example, the base station may be at least one of a gNode B, an eNode B, a Node B, a radio access unit, a base station controller, and a node on a network. The terminal may include a user equipment (UE), a mobile station (MS), a mobile phone, a smart phone, a computer or multimedia system capable of performing communication functions. In some embodiments of the disclosure, the downlink (DL) is a wireless transmission path through which signals are transmitted from a base station to a terminal, and the uplink (UL) is a wireless transmission path through which signals are transmitted from a terminal to a base station. In addition, one or more embodiments of the disclosure may be applied to 5G wireless communication technologies (5G, new radio (NR)) developed after LTE-A, or to new wireless communication technologies proposed on the basis of 4G or 5G (for example, B5G (Beyond 5G) or 6G).

In describing a wireless communication system and in the disclosure described below, higher layer signaling or higher layer signals are signal transferring methods for transferring information from a base station to a terminal through a downlink data channel of a physical layer or from a terminal to a base station through an uplink data channel of a physical layer, and examples of the signal transferring methods may include signal transferring methods for transferring information by Radio Resource Control (RRC) signaling, Packet Data Convergence Protocol (PDCP) signaling, or a Medium Access Control (MAC) Control Element (MAC CE).

Hereinafter, the embodiments of the disclosure will be described in detail with reference to the accompanying drawings. It should be noted that the same reference numerals in different drawings will be used to refer to the same elements already described.

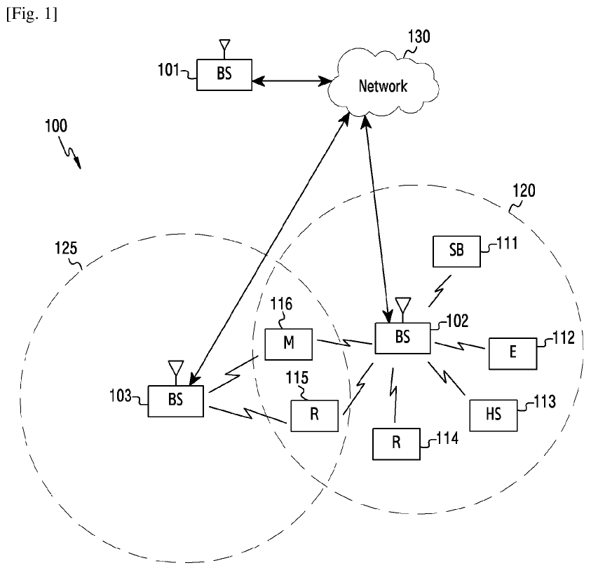

FIGS. 1-3B below describe various embodiments implemented by using orthogonal frequency division multiplexing (OFDM) or orthogonal frequency division multiple access (OFDMA) communication technologies in wireless communication systems. The descriptions of FIGS. 1-3B do not mean physical or architectural implications for the manner in which different embodiments may be implemented. Different embodiments of the disclosure may be implemented in any suitably arranged communication systems.

FIG. 1 illustrates an example wireless network 100 according to various embodiments of the disclosure. The embodiment of the wireless network 100 shown in FIG. 1 is for illustration only. Other embodiments of the wireless network 100 can be used without departing from the scope of the disclosure.

The wireless network 100 includes a gNodeB (gNB) 101, a gNB 102, and a gNB 103. gNB 101 communicates with gNB 102 and gNB 103. gNB 101 also communicates with at least one Internet Protocol (IP) network 130, such as the Internet, a private IP network, or other data networks.

Depending on a type of the network, other well-known terms such as “base station” or “access point” can be used instead of “gNodeB” or “gNB”. For convenience, the terms “gNodeB” and “gNB” are used in this patent document to refer to network infrastructure components that provide wireless access for remote terminals. And, depending on the type of the network, other well-known terms such as “mobile station”, “user station”, “remote terminal”, “wireless terminal” or “user apparatus” can be used instead of “user equipment” or “UE”. For convenience, the terms “user equipment” and “UE” are used in this patent document to refer to remote wireless devices that wirelessly access the gNB, no matter whether the UE is a mobile device (such as a mobile phone or a smart phone) or a fixed device (such as a desktop computer or a vending machine).

gNB 102 provides wireless broadband access to the network 130 for a first plurality of User Equipments (UEs) within a coverage area 120 of gNB 102. The first plurality of UEs include a UE 111, which may be located in a Small Business (SB); a UE 112, which may be located in an enterprise (E); a UE 113, which may be located in a WiFi Hotspot (HS); a UE 114, which may be located in a first residence (R); a UE 115, which may be located in a second residence (R); a UE 116, which may be a mobile device (M), such as a cellular phone, a wireless laptop computer, a wireless PDA, etc. GNB 103 provides wireless broadband access to network 130 for a second plurality of UEs within a coverage area 125 of gNB 103. The second plurality of UEs include a UE 115 and a UE 116. In some embodiments, one or more of gNBs 101-103 can communicate with each other and with UEs 111-116 using 5G, Long Term Evolution (LTE), LTE-A, WiMAX or other advanced wireless communication technologies.

The dashed lines show approximate ranges of the coverage areas 120 and 125, and the ranges are shown as approximate circles merely for illustration and explanation purposes. It should be clearly understood that the coverage areas associated with the gNBs, such as the coverage areas 120 and 125, may have other shapes, including irregular shapes, depending on configurations of the gNBs and changes in the radio environment associated with natural obstacles and man-made obstacles.

As will be described in more detail below, one or more of gNB 101, gNB 102, and gNB 103 include a 2D antenna array as described in embodiments of the disclosure. In some embodiments, one or more of gNB 101, gNB 102, and gNB 103 support codebook designs and structures for systems with 2D antenna arrays.

Although FIG. 1 illustrates an example of the wireless network 100, various changes can be made to FIG. 1. The wireless network 100 can include any number of gNBs and any number of UEs in any suitable arrangement, for example. Furthermore, gNB 101 can directly communicate with any number of UEs and provide wireless broadband access to the network 130 for those UEs. Similarly, each gNB 102-103 can directly communicate with the network 130 and provide direct wireless broadband access to the network 130 for the UEs. In addition, gNB 101, 102 and/or 103 can provide access to other or additional external networks, such as external telephone networks or other types of data networks.

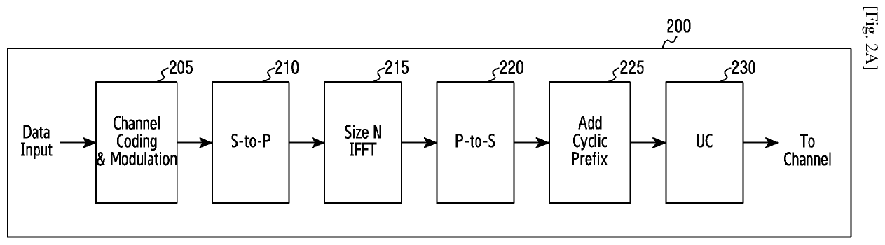

FIGS. 2A and 2B illustrate example wireless transmission and reception paths according to the disclosure. In the following description, the transmission path 200 can be described as being implemented in a gNB, such as gNB 102, and the reception path 250 can be described as being implemented in a UE, such as UE 116. However, it should be understood that the reception path 250 can be implemented in a gNB and the transmission path 200 can be implemented in a UE. In some embodiments, the reception path 250 is configured to support codebook designs and structures for systems with 2D antenna arrays as described in embodiments of the disclosure.

The transmission path 200 includes a channel coding and modulation block 205, a Serial-to-Parallel (S-to-P) block 210, a size N Inverse Fast Fourier Transform (IFFT) block 215, a Parallel-to-Serial (P-to-S) block 220, a cyclic prefix addition block 225, and an up-converter (UC) 230. The reception path 250 includes a down-converter (DC) 255, a cyclic prefix removal block 260, a Serial-to-Parallel (S-to-P) block 265, a size N Fast Fourier Transform (FFT) block 270, a Parallel-to-Serial (P-to-S) block 275, and a channel decoding and demodulation block 280.

In the transmission path 200, the channel coding and modulation block 205 receives a set of information bits, applies coding (such as Low Density Parity Check (LDPC) coding), and modulates the input bits (such as using Quadrature Phase Shift Keying (QPSK) or Quadrature Amplitude Modulation (QAM)) to generate a sequence of frequency-domain modulated symbols. The Serial-to-Parallel (S-to-P) block 210 converts (such as demultiplexes) serial modulated symbols into parallel data to generate N parallel symbol streams, where N is a size of the IFFT/FFT used in gNB 102 and UE 116. The size N IFFT block 215 performs IFFT operations on the N parallel symbol streams to generate a time-domain output signal. The Parallel-to-Serial block 220 converts (such as multiplexes) parallel time-domain output symbols from the Size N IFFT block 215 to generate a serial time-domain signal. The cyclic prefix addition block 225 inserts a cyclic prefix into the time-domain signal. The up-converter 230 modulates (such as up-converts) the output of the cyclic prefix addition block 225 to an RF frequency for transmission via a wireless channel. The signal can also be filtered at a baseband before switching to the RF frequency.

The RF signal transmitted from gNB 102 arrives at UE 116 after passing through the wireless channel, and operations in reverse to those at gNB 102 are performed at UE 116. The down-converter 255 down-converts the received signal to a baseband frequency, and the cyclic prefix removal block 260 removes the cyclic prefix to generate a serial time-domain baseband signal. The Serial-to-Parallel block 265 converts the time-domain baseband signal into a parallel time-domain signal. The Size N FFT block 270 performs an FFT algorithm to generate N parallel frequency-domain signals. The Parallel-to-Serial block 275 converts the parallel frequency-domain signal into a sequence of modulated data symbols. The channel decoding and demodulation block 280 demodulates and decodes the modulated symbols to recover the original input data stream.

Each of gNBs 101-103 may implement a transmission path 200 similar to that for transmitting to UEs 111-116 in the downlink, and may implement a reception path 250 similar to that for receiving from UEs 111-116 in the uplink. Similarly, each of UEs 111-116 may implement a transmission path 200 for transmitting to gNBs 101-103 in the uplink, and may implement a reception path 250 for receiving from gNBs 101-103 in the downlink.

Each of the components in FIGS. 2A and 2B can be implemented using only hardware, or using a combination of hardware and software/firmware. As a specific example, at least some of the components in FIGS. 2A and 2B may be implemented in software, while other components may be implemented in configurable hardware or a combination of software and configurable hardware. For example, the FFT block 270 and IFFT block 215 may be implemented as configurable software algorithms, in which the value of the size N may be modified according to the implementation.

Furthermore, although described as using FFT and IFFT, this is only illustrative and should not be interpreted as limiting the scope of the disclosure. Other types of transforms can be used, such as Discrete Fourier transform (DFT) and Inverse Discrete Fourier Transform (IDFT) functions. It should be understood that for DFT and IDFT functions, the value of variable N may be any integer (such as 1, 2, 3, 4, etc.), while for FFT and IFFT functions, the value of variable N may be any integer which is a power of 2 (such as 1, 2, 4, 8, 16, etc.).

Although FIGS. 2A and 2B illustrate examples of wireless transmission and reception paths, various changes may be made to FIGS. 2A and 2B. For example, various components in FIGS. 2A and 2B can be combined, further subdivided or omitted, and additional components can be added according to specific requirements. Furthermore, FIGS. 2A and 2B are intended to illustrate examples of types of transmission and reception paths that can be used in a wireless network. Any other suitable architecture can be used to support wireless communication in a wireless network.

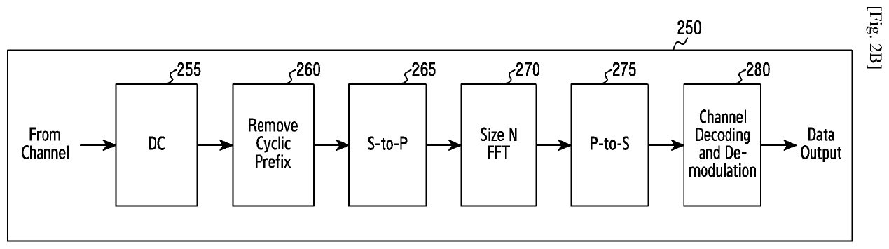

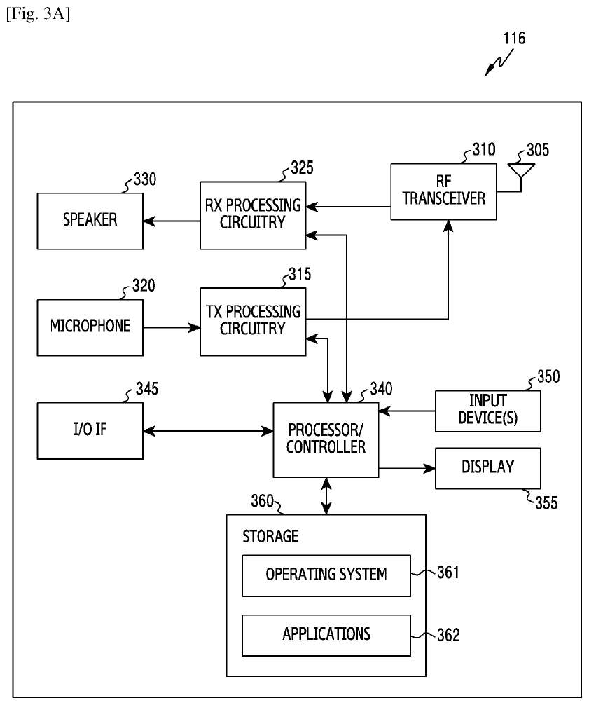

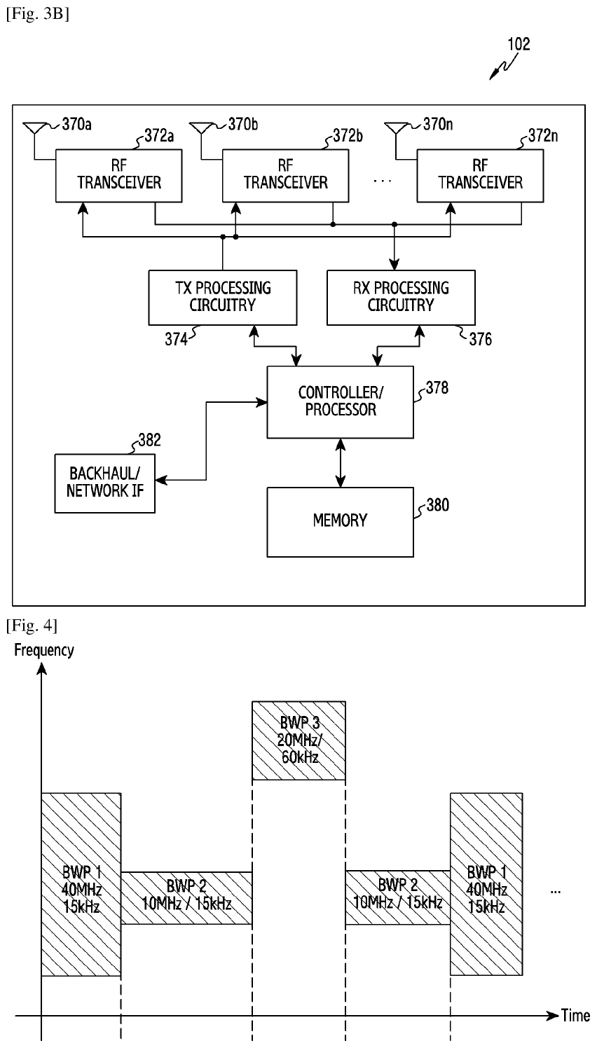

FIG. 3A illustrates an example UE 116 according to the disclosure. The embodiment of UE 116 shown in FIG. 3A is for illustration only, and UEs 111-115 of FIG. 1 can have the same or similar configuration. However, a UE has various configurations, and FIG. 3A does not limit the scope of the disclosure to any specific implementation of the UE.

UE 116 includes an antenna 305, a radio frequency (RF) transceiver 310, a transmission (TX) processing circuit 315, a microphone 320, and a reception (RX) processing circuit 325. UE 116 also includes a speaker 330, a processor/controller 340, an input/output (I/O) interface 345, an input device(s) 350, a display 355, and a memory 360. The memory 360 includes an operating system (OS) 361 and one or more applications 362.

The RF transceiver 310 receives an incoming RF signal transmitted by a gNB of the wireless network 100 from the antenna 305. The RF transceiver 310 down-converts the incoming RF signal to generate an intermediate frequency (IF) or baseband signal. The IF or baseband signal is transmitted to the RX processing circuit 325, where the RX processing circuit 325 generates a processed baseband signal by filtering, decoding and/or digitizing the baseband or IF signal. The RX processing circuit 325 transmits the processed baseband signal to speaker 330 (such as for voice data) or to processor/controller 340 for further processing (such as for web browsing data).

The TX processing circuit 315 receives analog or digital voice data from microphone 320 or other outgoing baseband data (such as network data, email or interactive video game data) from processor/controller 340. The TX processing circuit 315 encodes, multiplexes, and/or digitizes the outgoing baseband data to generate a processed baseband or IF signal. The RF transceiver 310 receives the outgoing processed baseband or IF signal from the TX processing circuit 315 and up-converts the baseband or IF signal into an RF signal transmitted via the antenna 305.

The processor/controller 340 can include one or more processors or other processing devices and execute an OS 361 stored in the memory 360 in order to control the overall operation of UE 116. For example, the processor/controller 340 can control the reception of forward channel signals and the transmission of backward channel signals through the RF transceiver 310, the RX processing circuit 325 and the TX processing circuit 315 according to well-known principles. In some embodiments, the processor/controller 340 includes at least one microprocessor or microcontroller.

The processor/controller 340 is also capable of executing other processes and programs residing in the memory 360, such as operations for channel quality measurement and reporting for systems with 2D antenna arrays as described in embodiments of the disclosure. The processor/controller 340 can move data into or out of the memory 360 as required by an execution process. In some embodiments, the processor/controller 340 is configured to execute the application 362 based on the OS 361 or in response to signals received from the gNB or the operator. The processor/controller 340 is also coupled to an I/O interface 345, where the I/O interface 345 provides UE 116 with the capability to connect to other devices such as laptop computers and handheld computers. I/O interface 345 is a communication path between these accessories and the processor/controller 340.

The processor/controller 340 is also coupled to the input device(s) 350 and the display 355. An operator of UE 116 can input data into UE 116 using the input device(s) 350. The display 355 may be a liquid crystal display or other display capable of presenting text and/or at least limited graphics (such as from a website). The memory 360 is coupled to the processor/controller 340. A part of the memory 360 can include a random access memory (RAM), while another part of the memory 360 can include a flash memory or other read-only memory (ROM).

Although FIG. 3A illustrates an example of UE 116, various changes can be made to FIG. 3A. For example, various components in FIG. 3A can be combined, further subdivided or omitted, and additional components can be added according to specific requirements. As a specific example, the processor/controller 340 can be divided into a plurality of processors, such as one or more central processing units (CPUs) and one or more graphics processing units (GPUs). Furthermore, although FIG. 3A illustrates that the UE 116 is configured as a mobile phone or a smart phone, UEs can be configured to operate as other types of mobile or fixed devices.

FIG. 3B illustrates an example gNB 102 according to the disclosure. The embodiment of gNB 102 shown in FIG. 3B is for illustration only, and other gNBs of FIG. 1 can have the same or similar configuration. However, a gNB has various configurations, and FIG. 3B does not limit the scope of the disclosure to any specific implementation of a gNB. It should be noted that gNB 101 and gNB 103 can include the same or similar structures as gNB 102.

As shown in FIG. 3B, gNB 102 includes a plurality of antennas 370a-370n, a plurality of RF transceivers 372a-372n, a transmission (TX) processing circuit 374, and a reception (RX) processing circuit 376. In certain embodiments, one or more of the plurality of antennas 370a-370n include a 2D antenna array. gNB 102 also includes a controller/processor 378, a memory 380, and a backhaul or network interface 382.

RF transceivers 372a-372n receive an incoming RF signal from antennas 370a-370n, such as a signal transmitted by UEs or other gNBs. RF transceivers 372a-372n down-convert the incoming RF signal to generate an IF or baseband signal. The IF or baseband signal is transmitted to the RX processing circuit 376, where the RX processing circuit 376 generates a processed baseband signal by filtering, decoding and/or digitizing the baseband or IF signal. RX processing circuit 376 transmits the processed baseband signal to controller/processor 378 for further processing.

The TX processing circuit 374 receives analog or digital data (such as voice data, network data, email or interactive video game data) from the controller/processor 378. TX processing circuit 374 encodes, multiplexes and/or digitizes outgoing baseband data to generate a processed baseband or IF signal. RF transceivers 372a-372n receive the outgoing processed baseband or IF signal from TX processing circuit 374 and upconvert the baseband or IF signal into an RF signal transmitted via antennas 370a-370n.

The controller/processor 378 can include one or more processors or other processing devices that control the overall operation of gNB 102. For example, the controller/processor 378 can control the reception of forward channel signals and the transmission of backward channel signals through the RF transceivers 372a-372n, the RX processing circuit 376 and the TX processing circuit 374 according to well-known principles. The controller/processor 378 can also support additional functions, such as higher-level wireless communication functions. For example, the controller/processor 378 can perform a Blind Interference Sensing (BIS) process such as that performed through a BIS algorithm, and decode a received signal from which an interference signal is subtracted. A controller/processor 378 may support any of a variety of other functions in gNB 102. In some embodiments, the controller/processor 378 includes at least one microprocessor or microcontroller.

The controller/processor 378 is also capable of executing programs and other processes residing in the memory 380, such as a basic OS. The controller/processor 378 can also support channel quality measurement and reporting for systems with 2D antenna arrays as described in embodiments of the disclosure. In some embodiments, the controller/processor 378 supports communication between entities such as web RTCs. The controller/processor 378 can move data into or out of the memory 380 as required by an execution process.

The controller/processor 378 is also coupled to the backhaul or network interface 382. The backhaul or network interface 382 allows gNB 102 to communicate with other devices or systems through a backhaul connection or through a network. The backhaul or network interface 382 can support communication over any suitable wired or wireless connection(s). For example, when gNB 102 is implemented as a part of a cellular communication system, such as a cellular communication system supporting 5G or new radio access technology or NR, LTE or LTE-A, the backhaul or network interface 382 can allow gNB 102 to communicate with other gNBs through wired or wireless backhaul connections. When gNB 102 is implemented as an access point, the backhaul or network interface 382 can allow gNB 102 to communicate with a larger network, such as the Internet, through a wired or wireless local area network or through a wired or wireless connection. The backhaul or network interface 382 includes any suitable structure that supports communication through a wired or wireless connection, such as an Ethernet or an RF transceiver.

The memory 380 is coupled to the controller/processor 378. A part of the memory 380 can include an RAM, while another part of the memory 380 can include a flash memory or other ROMs. In certain embodiments, a plurality of instructions, such as the BIS algorithm, are stored in the memory. The plurality of instructions are configured to cause the controller/processor 378 to execute the BIS process and decode the received signal after subtracting at least one interference signal determined by the BIS algorithm.

As will be described in more detail below, the transmission and reception paths of gNB 102 (implemented using RF transceivers 372a-372n, TX processing circuit 374 and/or RX processing circuit 376) support aggregated communication with FDD cells and TDD cells.

Although FIG. 3B illustrates an example of gNB 102, various changes may be made to FIG. 3B. For example, gNB 102 can include any number of each component shown in FIG. 3A. As a specific example, the access point can include many backhaul or network interfaces 382, and the controller/processor 378 can support routing functions to route data between different network addresses. As another specific example, although shown as including a single instance of the TX processing circuit 374 and a single instance of the RX processing circuit 376, gNB 102 can include multiple instances of each (such as one for each RF transceiver).

Exemplary embodiments of the disclosure are further described below in combination with the accompany drawings.

Communication systems (e.g., NR) may support Bandwidth Adaptation (BA) where a reception and/or transmission bandwidth is adjustable. For example, a terminal may change the reception and/or transmission bandwidth, e.g., shrinking during low activity to save power. For example, the terminal may change a position of the reception and/or transmission bandwidth in frequency domain, for example, to increase the flexibility of scheduling. For example, the terminal (e.g., UE) may change a subcarrier spacing, for example, to allow different services.

In example embodiments, a subset of a total cell bandwidth of a cell can be referred to as a bandwidth part (BWP). A base station may configure one or more BWPs for a terminal to realize the BA. One of one or more BWPs may be activated, and the activated BWP is an active BWP. For example, the base station may indicate, to the terminal (e.g., UE), which of one or more (configured) BWPs is the active BWP. The base station may configure the active BWP for the terminal, for example, through higher layer signaling (e.g., RRC signaling or MAC signaling) or physical layer signaling (e.g., Downlink Control Information (DCI) carried by a Physical Downlink Control Channel (PDCCH)). The base station may also indicate a BWP change from the activated (or active) BWP to another BWP through signaling (e.g., DCI). When the terminal receives the indication of the BWP change, the activated BWP is deactivated, and the other BWP is activated, that is, is changed to an active BWP.

FIG. 4 is a schematic diagram of an example scenario in which three BWPs are configured, where the three BWPs include: BWP1 (410 and 450) with a bandwidth of 40 MHz and a subcarrier spacing of 15 kHz; BWP2 (420 and 440) with a bandwidth of 10 MHz and a subcarrier spacing of 15 kHz; BWP3 430 with a bandwidth of 20 MHz and a subcarrier spacing of 60 kHz. As an application example of the example scenario of FIG. 4, as shown in FIG. 4, in the first time unit, traffic of a UE is larger, and a larger bandwidth (BWP1) may be configured for the UE; in the second time unit, the traffic of the UE is smaller, so it is enough to configure a smaller bandwidth (BWP2) for the UE to meet basic communication demands; and in the third time unit, if it is found that there is a wide range of frequency selective fading in a bandwidth where BWP1 is located, or resources in a frequency range where BWP1 is located are scarce, a new bandwidth (BWP3) may be configured for the UE. In the corresponding BWP, the UE is only required to adopt a central frequency point and sampling rate of the corresponding BWP. Moreover, each BWP is not only different in a frequency point and bandwidth, but also may correspond to different configurations. For example, a subcarrier spacing, a cyclic prefix (CP) type, an SSB (Synchronization Signal and PBCH block) (including Primary Synchronization Signal (PSS), Secondary Synchronization Signal (SSS) and PBCH) period and/or the like may be configured differently for each BWP to adapt to different services. In example embodiments, A UL BWP or DL BWP may be defined by at least one of the following parameters: a subcarrier spacing, a CP, or a bandwidth (e.g., a position and number of consecutive PRBs).

In the existing communication systems (e.g. LTE, NR, etc.), in order to avoid self-interference caused by transmission of the same communication node to reception, it is usually ensured that there is an enough frequency domain guard interval between an uplink band and a downlink band, or the same uplink and downlink configuration is maintained on bandwidths adjacent to each other. For example, in systems adopting frequency division duplex (FDD), there is a frequency domain guard interval between the uplink band and the downlink band. For example, the interval between the uplink band and the downlink band in NR systems may reach about 20 MHz, thus ensuring that the receiving performance will not be degraded due to self-interference of adjacent band leakage when a base station and a terminal simultaneously perform an uplink transmission and a downlink transmission. For example, in NR systems, UL-DL configurations of different BWPs in the same carrier are required to be consistent, that is, an uplink transmission or a downlink transmission is simultaneously performed on different bandwidth parts of a single carrier at the same time, thus avoiding self-interference caused by simultaneous signal reception and signal transmission by the base station or the terminal on BWPs adjacent to each other.

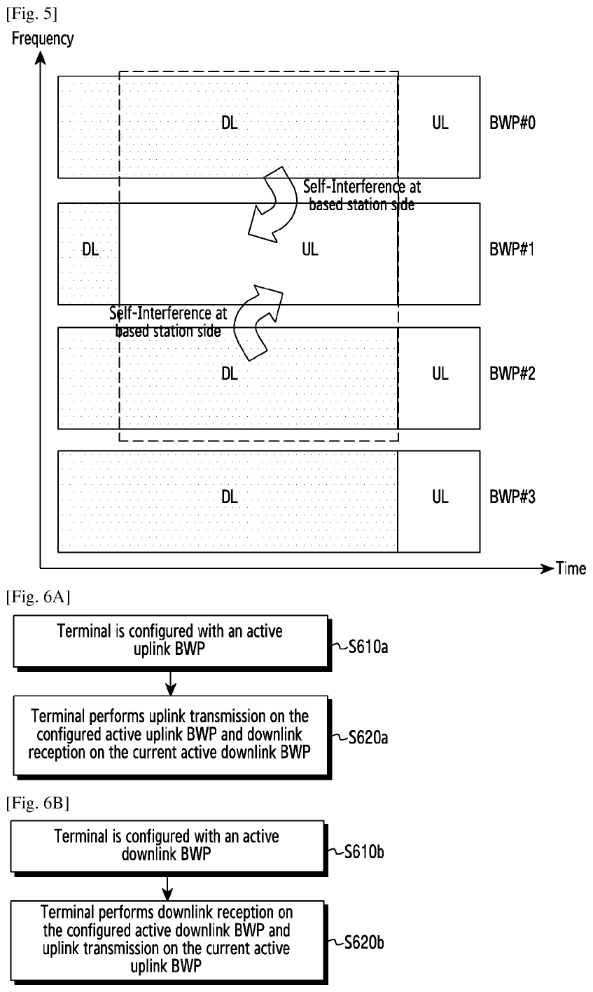

In systems supporting flexible duplex, UL-DL configurations of multiple BWPs within a system bandwidth may be different. In this case, there may be a self-interference problem. Examples of the flexible duplex include XDD (Cross Division Duplex) (referring to Hyoungju Ji et al., “Extending 5G TDD Coverage With XDD: Cross Division Duplex,” IEEE Access, vol. 9, pp. 51380-51392, 2021, doi: 10.1109/ACCESS.2021.3068977). FIG. 5 illustrates an example of self-interference at a base station side when different BWPs in a single carrier have different UL-DL configurations in systems supporting flexible duplex. In order to solve the problem of self-interference, the UL-DL configurations of the multiple BWPs within the system bandwidth may be required to be consistent. However, if the UL-DL configurations of the multiple BWPs within the system bandwidth are required to be consistent, users with different ratios of uplink traffic and downlink traffic cannot be satisfied at the same time. In actual systems, in order to ensure downlink coverage, a configuration proportion of downlink physical resources is usually higher than that of uplink physical resources, so there may be problems such as a limited uplink coverage for users who are mainly engaged in uplink services. If the base station has a capability of self-interference cancellation, different UL-DL configurations may be configured for different BWPs to adapt to service demands of different users. Self-interference cancellation at the base station side may be achieved by upgrading of hardware and software algorithms. For the terminal, when BWPs with different UL-DL configurations are configured in the same carrier, enabling the terminal to support performing an uplink transmission and a downlink reception in different BWPs separately (for example, the uplink transmission is performed in one BWP and the downlink reception is performed in another BWP) may effectively reduce transmission delay while meeting transmission requirements of terminals with a limited uplink and downlink coverage. For example, the terminal may perform the uplink transmission in a BWP with a higher proportion of uplink slot/symbol and perform the downlink reception in a BWP with a higher proportion of downlink slot/symbols.

However, existing systems may not support such terminal operation. In existing systems, considering the demand of power saving of a terminal, when the system bandwidth is an asymmetric spectrum, it is only supported that an active uplink (UL) BWP and an active downlink (DL) BWP of the terminal are the same, that is, the uplink and downlink transmission of the terminal can be performed only on the same BWP. Although existing systems may also support active uplink BWP/active downlink BWP change (e.g., switch) of the terminal, for systems with the asymmetric spectrum, even if only one of the active uplink BWP and the active downlink BWP is changed, the other one is required to be changed synchronously to keep the active uplink BWP the same as the active downlink BWP; after completing the change of the active BWP, the terminal performs an uplink transmission and a downlink reception on the changed active BWP, including monitoring downlink control channels and receiving system messages, and/or the like. In addition, it takes a change time of several slots for the terminal to perform the change of the active BWP, where a length of the change time is related to a capability reported by the users.

In order to support a terminal to perform an uplink transmission and a downlink reception on different BWPs separately, it is required to introduce a new design. For example, considering demands such as power saving and a bandwidth capability of the terminal, it is required to consider a change mechanism between an active uplink BWP and an active downlink BWP for the terminal, including a change opportunity design, a change duration design, and an capability reporting design related to active BWP change of the active uplink/downlink BWP, etc.

In order to solve at least one or more of the above problems, embodiments of the disclosure provide a method and apparatus for determining an active BWP for uplink transmissions and/or an active BWP for downlink transmissions. For example, the method according to embodiments of the disclosure provides a change opportunity design, a change duration design, and a capability reporting design related to the active BWP change between active uplink and downlink BWPs for a terminal, etc., so that the terminal may perform an uplink transmission and a downlink reception on different BWPs separately, thereby obtaining the benefits of enhancing the uplink/downlink coverage and reducing the transmission delay in flexible duplex systems. In embodiments of the disclosure, that “a first BWP is different from a second BWP” may at least indicate that a bandwidth of the first BWP (e.g., a position/number of consecutive PRBs) is different from that of the second BWP.

In example embodiments, the terminal is configured with an active uplink BWP or an active downlink BWP through higher layer signaling or DCI (e.g., a DCI format). In particular, for systems with asymmetric spectrum, the active uplink BWP and the active downlink BWP configured for the terminal may be different BWPs. For example, the higher layer signaling for configuring the active uplink/downlink BWP may be RRC signaling.

FIGS. 6A and 6B illustrate flowcharts of methods performed by a terminal according to some embodiments of the disclosure.

Referring to FIG. 6A, in operation S610a, the terminal is configured with an active uplink BWP. For example, the terminal may be configured with the active uplink BWP through higher layer signaling (e.g., RRC signaling) or DCI (e.g., a DCI format).

In operation S620a, the terminal performs an uplink transmission on the configured active uplink BWP and a downlink reception on a current active downlink BWP. For systems with asymmetric spectrum, when the terminal is configured with the active uplink BWP through the higher layer signaling or DCI, the terminal performs the uplink transmission in the configured active uplink BWP and the downlink reception in the current active downlink BWP, where the current active downlink BWP and the configured active uplink BWP may be different BWPs. In embodiments of the disclosure, a “current active downlink BWP” may refer to a BWP on which the terminal is currently performing the downlink reception, and a “current active uplink BWP” may refer to a BWP on which the terminal is currently performing the uplink transmission.

By the method according to the embodiment of FIG. 6A, the terminal can be configured to perform the uplink transmission and the downlink reception on different BWPs separately (for example, perform the uplink transmission on the configured active uplink BWP and the downlink reception on the current active downlink BWP which is different from the configured active uplink BWP), and the current transmission (e.g., in the embodiment of FIG. 6A, the downlink transmission) of a transmission direction in which the terminal is not configured with BWP change is less affected.

Referring to FIG. 6B, in operation S610b, the terminal is configured with an active downlink BWP. For example, the terminal may be configured with the active downlink BWP through higher layer signaling (e.g., RRC signaling) or DCI (e.g., a DCI format).

In operation S620b, the terminal performs a downlink reception on the configured active downlink BWP and an uplink transmission on a current active uplink BWP. For systems with asymmetric spectrum, when the terminal is configured with the active downlink BWP through the higher layer signaling or the DCI, the terminal performs the downlink reception in the configured active downlink BWP and the uplink transmission in the current active uplink BWP, where the current active uplink BWP and the configured active downlink BWP are different.

By the method according to the embodiment of FIG. 6B, the terminal can be configured to perform the uplink transmission and the downlink reception on different BWPs separately (for example, perform the downlink reception on the configured active downlink BWP and the uplink transmission on the current active uplink BWP which is different from the configured active downlink BWP), and the current transmission (e.g., in the embodiment of FIG. 6A, the uplink transmission) of a transmission direction in which the terminal is not configured with BWP change is less affected.

Various embodiments that may be used in combination with the embodiments of FIGS. 6A and/or 6B are described below.

In example embodiments, when an active uplink BWP configured for the terminal through higher layer signaling (e.g., RRC signaling) or DCI (e.g., a DCI format) and a current active uplink BWP are different, the terminal performs an active uplink BWP change, that is, changes the current active uplink BWP to the configured active uplink BWP, and performs an uplink transmission on the changed active uplink BWP. For systems with asymmetric spectrum, even if the active uplink BWP configured for the terminal and the current active downlink BWP of the terminal are different, the terminal performs a downlink reception in the current active downlink BWP; that is, based on the change of the active uplink BWP, an association relationship between the current active downlink BWP and the current active uplink BWP is replaced, so that the uplink transmission and the downlink reception are performed on different BWPs separately.

In example embodiments, the terminal does not perform an uplink transmission and a downlink reception within a predetermined time for a BWP change (which may also be referred to as a “predetermined BWP change time” in embodiments of the disclosure). For example, the predetermined BWP change time may be a time required for a change between an active uplink BWP and an active downlink BWP, which is determined based on capability information reported by the terminal. Note that when the active uplink BWP and the active downlink BWP of the terminal are the same, the predetermined BWP change time may be 0, which means that the BWP change is not required to be performed.

In example embodiments, when the terminal receives a Physical Downlink Shared Channel (PDSCH) in an active downlink BWP, the terminal determines a time when HARQ (Hybrid Automatic Repeat Request) information (e.g., acknowledgement (ACK)/negative acknowledgement (NACK)) of the PDSCH is fed back according to whether an active uplink BWP and the active downlink BWP are the same. For example, when the active uplink BWP and the active downlink BWP of the terminal are the same, the time when the HARQ information is fed back is not related to a predetermined BWP change time; when the active uplink BWP and the active downlink BWP of the terminal are different, the time when the HARQ information is fed back is related to the predetermined BWP change time. In a specific instance, when the active uplink BWP and the active downlink BWP of the terminal are the same, the terminal determines a slot in which the HARQ information (e.g., ACK/NACK) of the PDSCH is fed back, according to a PDSCH-to-HARQ feedback timing indicator in DCI (e.g., a DCI format); when the active uplink BWP and the active downlink BWP of the terminal are different, the terminal determines the slot in which the HARQ information (e.g., ACK/NACK) of the PDSCH is fed back, according to the PDSCH-to-HARQ feedback timing indicator in the DCI (e.g., the DCI format) and the predetermined BWP change time. For example, if the last slot in which the terminal performs the PDSCH reception is slot n (n is a slot index), when the active uplink BWP and the active downlink BWP of the terminal are different, the terminal may determine to feed back the HARQ information (for example, transmit through a Physical Uplink Control Channel (PUCCH)) in slot n+N, where N=N_{TA}+N_{switch}, where N_{TA} is the number of slots indicated by the PDSCH-to-HARQ feedback timing indicator in the DCI (e.g., the DCI format), and N_{switch} is the predetermined BWP change time.

In example embodiments, when the terminal receives DCI (e.g., a DCI format) in an active downlink BWP, the terminal determines a starting time of a physical uplink channel (e.g., a PUCCH or a Physical Uplink Shared Channel (PUSCH)) transmission according to whether an active uplink BWP and the active downlink BWP are the same. For example, when the active uplink BWP and the active downlink BWP of the terminal are the same, the starting time of the physical uplink channel transmission is not related to a predetermined BWP change time; when the active uplink BWP and the active downlink BWP of the terminal are different, the starting time of the physical uplink channel transmission is related to the predetermined BWP change time. In a specific instance, when the active uplink BWP and the active downlink BWP of the terminal are the same, the terminal determines the starting time for transmitting the scheduled physical uplink channel (e.g., the PUCCH or the PUSCH) according to a time domain assignment indication in the DCI (e.g., the DCI format); when the active uplink BWP and the active downlink BWP of the terminal are different, the terminal determines the starting time for transmitting the scheduled physical uplink channel (e.g., the PUCCH or the PUSCH) according to the time domain resource assignment indication in the DCI (e.g., the DCI format) and the predetermined BWP change time. For example, if a slot in which the terminal receives the DCI (e.g., the DCI format) is slot n, when the active uplink BWP and the active downlink BWP of the terminal are different, the terminal may determine to transmit the PUSCH in a slot not earlier than slot n+N, where N=K₂+N_{switch}, where K₂ is an uplink scheduling offset, that is, a minimum interval between the slot in which the DCI (e.g., the DCI format) is received and a starting slot in which the PUSCH is transmitted, and N_{switch} is the predetermined BWP change time.

In example embodiments, when an active uplink BWP and an active downlink BWP of the terminal are different, and the current transmission of the terminal is in the active uplink BWP, the terminal performs a BWP change to the active downlink BWP before receiving a specific downlink signal/channel. For example, the specific downlink signal/channel includes at least one of: a synchronization signal and physical broadcast channel block (SSB), a PDCCH of Common Search Space (CSS), a PDCCH of UE-specific Search Space (USS), and a System Information Block (SIB). In this way, the downlink reception of key information such as information of downlink synchronization, system messages and DCI by the terminal can be ensured. In some implementations, in N_{switch} time units before a time unit in which the terminal receives the specific downlink signal/channel, the terminal does not perform an uplink transmission and a downlink reception, where N_{switch} is a predetermined BWP change time, thereby ensuring that the terminal changes from the active uplink BWP to the active downlink BWP.

In example embodiments, a time required for change between an active uplink BWP and an active downlink BWP (e.g., a predetermined BWP change time) may be determined according to capability information related to a multi-BWP operation reported by the terminal. In some implementations, the capability information related to the multi-BWP operation may include at least one of: a capability to support performing an uplink transmission on more than one BWP simultaneously; a capability to support performing a downlink reception on more than one BWP simultaneously; or a capability to support performing an uplink transmission and a downlink reception on different BWPs separately (for example, performing the uplink transmission on a BWP and the downlink reception on another BWP). In some implementations, the determining of the time required for change between the active uplink BWP and the active downlink BWP according to the capability information reported by the terminal may include that, when the terminal reports that the multi-BWP operation is supported (that is, the terminal supports performing an uplink transmission on more than one BWP simultaneously, and/or performing a downlink reception on more than one BWP simultaneously, and/or performing an uplink transmission and a downlink reception on different BWPs separately), the time required for change between the active uplink BWP and the active downlink BWP may be 0, that is, the change time is not required (or the BWP change is not required).

In example embodiments, there may be an association between BWP configuration parameters for configuring different BWPs. For example, when an active uplink BWP is configured for the terminal by a first BWP configuration parameter and an active downlink BWP is configured for the terminal by a second BWP configuration parameter, the association of the first BWP configuration parameter with the second BWP configuration parameter may be at least one of that: the configured active uplink BWP and the configured active downlink BWP have the same subcarrier spacing; the configured active uplink BWP and the configured active downlink BWP have the same bandwidth; the bandwidth of the configured active uplink BWP is adjacent to the configured active downlink BWP; and the total bandwidth of the configured active uplink BWP and the configured active downlink BWP is not greater than the maximum bandwidth supported by the bandwidth capability of the user. The association of the first BWP configuration parameter with the second BWP configuration parameter may be pre-specified or predefined by communication specifications, or the association of the first BWP configuration parameter with the second BWP configuration parameter may be indicated by higher layer signaling. In some implementations, when one of the first BWP configuration parameter and the second BWP configuration parameter is determined (for example, received from a base station), the terminal may directly determine the other of the first BWP configuration parameter and the second BWP configuration parameter based on the association of the first BWP configuration parameter with the second BWP configuration parameter. In this way, the time for the terminal to perform the BWP change (e.g., switch) may be reduced to a certain extent by associating the first BWP configuration parameter for configuring the active uplink BWP with the second BWP configuration parameter for configuring the active downlink BWP.

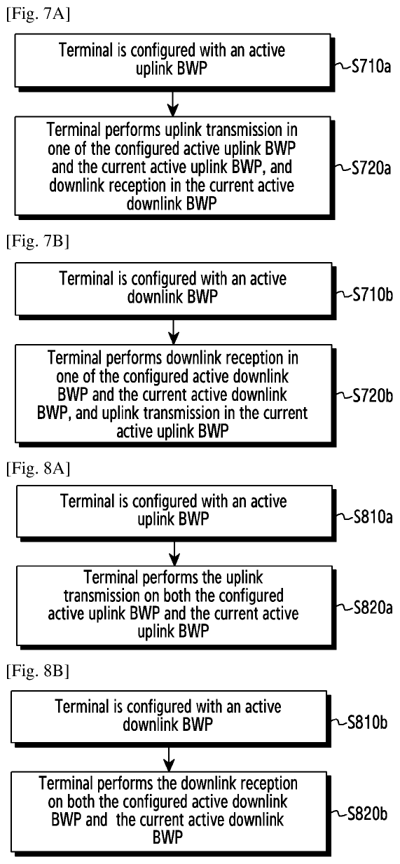

FIGS. 7A and 7B illustrate flowcharts of methods performed by a terminal according to some embodiments of the disclosure.

Referring to FIG. 7A, in operation S710a, the terminal is configured with an active uplink BWP. For example, the terminal may be configured with the active uplink BWP through higher layer signaling (e.g., RRC signaling) or DCI (e.g., a DCI format).

In operation S720a, the terminal performs an uplink transmission in one of the configured active uplink BWP and a current active uplink BWP, and a downlink reception in a current active downlink BWP. In particular, for systems with asymmetric spectrum, when the terminal is configured with the active uplink BWP through the higher layer signaling (e.g., RRC signaling) or DCI (e.g., a DCI format), and the configured active uplink BWP is different from the current active uplink BWP of the terminal, the terminal performs the uplink transmission on one of the configured active uplink BWP and the current active uplink BWP, and the downlink reception on the current active downlink BWP, where the one of the configured active uplink BWP and the current active uplink BWP is different from the current active downlink BWP.

By the method according to the embodiment of FIG. 7A, the terminal may be configured to perform the uplink transmission and the downlink reception on different BWPs separately (for example, performing the uplink transmission on one of the configured active uplink BWP and the current active uplink BWP, and the downlink reception on the current active downlink BWP, where the one of the configured active uplink BWP and the current active uplink BWP is different from the current active downlink BWP), and it may also support a change (e.g., switch) of the uplink transmission between different active uplink BWPs or a change (e.g., switch) of the downlink reception between different active downlink BWPs.

Referring to FIG. 7B, in operation S710b, the terminal is configured with an active downlink BWP. For example, the terminal may be configured with the active downlink BWP through higher layer signaling (e.g., RRC signaling) or DCI (e.g., a DCI format).

In operation S720b, the terminal performs a downlink reception in one of the configured active downlink BWP and a current active downlink BWP, and an uplink transmission in the current active uplink BWP. In particular, for systems with asymmetric spectrum, when the terminal is configured with the active downlink BWP through the higher layer signaling (e.g., the RRC signaling) or the DCI (e.g., the DCI format), and the configured active downlink BWP is different from the current active downlink BWP of the terminal, the terminal performs the downlink reception on one of the configured active downlink BWP and the current active downlink BWP, and the uplink transmission on the current active uplink BWP, where the one of the configured active downlink BWP and the current active downlink BWP is different from the current active uplink BWP.

By the method according to the embodiment of FIG. 7B, the terminal may be configured to perform the uplink transmission and the downlink reception on different BWPs separately (for example, performing the downlink reception on one of the configured active downlink BWP and the current active downlink BWP, and the uplink transmission on the current active uplink BWP, where the one of the configured active downlink BWP and the current active downlink BWP is different from the current active uplink BWP), while it may also support a change (e.g., switch) of the uplink transmission between different active uplink BWPs or a change (e.g., switch) of the downlink reception between different active downlink BWPs.

Various embodiments that may be used in combination with the embodiments of FIGS. 7A and/or 7B are described below.

In example embodiments, for systems with asymmetric spectrum, when the terminal is configured with an active uplink BWP (or an active downlink BWP) (hereinafter referred to as “BWP_A”, which corresponds to the configured active BWP) through higher layer signaling (e.g., RRC signaling) or DCI (e.g., a DCI format), and a current active uplink BWP (or a current active downlink BWP) (hereinafter referred to as “BWP_B”, which corresponds to a current active BWP) of the terminal, the following methods may be adopted to determine the active BWP. According to a principle that an active uplink BWP and an active downlink BWP are the same in systems with asymmetric spectrum, even if BWP_A and BWP_B are only configured as the active uplink BWP, BWP_A and BWP_B should be the active downlink BWP; or, even if BWP_A and BWP_B are only configured as the active downlink BWP, BWP_A and BWP_B should be the active uplink BWP. That is, the terminal may perform an uplink transmission and/or a downlink reception in BWP_A, and may also perform the uplink transmission and/or the downlink reception in BWP_B. In this case, the terminal determines that a transmission of a specific uplink signal/channel and/or a reception of a specific downlink signal/channel is performed on one of BWP_A and BWP_B according to configurations or predetermined system rules. For example, the specific uplink signal/channel includes at least one of: a PUSCH, a PUCCH, and a Physical Random Access Channel (PRACH). For example, the specific downlink signal/channel includes at least one of: a PDSCH, a PDCCH of a CSS, a PDCCH of a USS, a SSB, and a SIB.

In some implementations, determining that the transmission of the specific uplink signal/channel and/or the reception of the specific downlink signal/channel is performed on one of BWP_A and BWP_B according to configurations or predetermined system rules may include that the terminal determines that the transmission of the specific uplink signal/channel or the specific downlink reception is performed on BWP_A or BWP_B, or that the transmission of the specific uplink signal/channel or the reception of the specific downlink signal/channel is performed on both BWP_A and BWP_B but not at the same time, according to higher layer signaling (e.g., RRC signaling) or DCI (e.g., a DCI format) or the predetermined system rules. In some implementations, BWPs allowed to be used may be different for different uplink transmissions or different downlink receptions. For example, the terminal may be configured with a transmission of an uplink signal/channel on BWP_A and a transmission of another uplink signal/channel on BWP_B; and/or the terminal may be configured with a reception of a downlink signal/channel on BWP_A and a reception of another downlink signal/channel on BWP_B. In one instance, the terminal may be configured with a transmission of a Physical Uplink Shared Channel (PUSCH) on BWP_A, and a transmission of a PUCCH, and/or a PRACH and/or a PUSCH on BWP_B; and/or the terminal may be configured with a reception of a PDSCH on BWP_A, and a reception of a PDCCH of CSS, and/or a PDCCH of a USS, and/or a SSB, and/or a SIB, and/or a PDSCH on BWP_B. In this way, BWP_B may be the current active uplink BWP and the current active downlink BWP of the terminal, and thus BWP_B undertakes most of signaling interaction and service data transmission within reach, such that delay overhead caused by BWP change (e.g., switch) may be reduced. In addition, when BWP_B cannot meet uplink/downlink data services of all users due to limited uplink/downlink resources, demands of the users can be met by performing uplink and downlink transmission on BWP_A, so as to achieve resource optimization of the system. In this instance, BWP_A may be regarded as a supplement to BWP_B, that is, BWP_B is a primary BWP and BWP_A is a secondary BWP.

In some implementations, the terminal has only one current active uplink/downlink BWP at the same time. Furthermore, when BWP_A and BWP_B are different, the terminal may change between BWP_A and BWP_B within a predetermined BWP change time. For example, “changing between BWP_A and BWP_B” means at least one of that: the current active uplink BWP is changed from BWP_A to BWP_B; the current active uplink BWP is changed from BWP_B to BWP_A; the current active downlink BWP is changed from BWP_A to BWP_B; or the current active downlink BWP is changed from BWP_B to BWP_A.

In example embodiments, the terminal does not perform an uplink transmission and a downlink reception within a predetermined BWP change time, where the predetermined BWP change time may be a time required for active BWP change, which is determined according to capability information reported by the terminal. Note that when BWP_A and BWP_B of the terminal are the same, or the active uplink BWP and the active downlink BWP of the terminal are the same BWP (BWP_A or BWP_B), the predetermined BWP change time may be 0, that is, the BWP change is not required.

In example embodiments, when the terminal receives a PDSCH in an active downlink BWP, the terminal determines a time for feeding back HARQ information (e.g., ACK/NACK) according to whether the active uplink BWP and an active downlink BWP are the same. For example, when the active uplink BWP and the active downlink BWP of the terminal are the same, the time for feeding back the HARQ information is not related to a predetermined BWP change time; when the active uplink BWP and the active downlink BWP of the terminal are different, the time for feeding back the HARQ information is related to the predetermined BWP change time. In a specific example, when the active uplink BWP and the active downlink BWP of the terminal are the same, the terminal determines a slot in which the HARQ information (e.g., ACK/NACK) of the PDSCH is fed back, according to a PDSCH-to-HARQ feedback timing indicator in DCI (e.g., a DCI format); when the active uplink BWP and the active downlink BWP of the terminal are different, the terminal determines the slot in which the HARQ information (e.g., ACK/NACK) of the PDSCH is fed back, according to the PDSCH-to-HARQ feedback timing indicator in the DCI (e.g., the DCI format) and the predetermined BWP change time. For example, if the last slot in which the terminal performs the PDSCH reception is slot n (n is a slot index), when the active uplink BWP and the active downlink BWP of the terminal are different, the terminal may determine to feed back the HARQ information of the PDSCH (for example, transmit the HARQ information of the PDSCH through a PUCCH) in slot n+N, where N=N_{TA}+N_{switch}, where N_{TA} is a number of slots indicated by the PDSCH-to-HARQ feedback timing indicator in the DCI (e.g., the DCI format), and N_{switch} is the predetermined BWP change time.

In example embodiments, when the terminal receives DCI (e.g., a DCI format) in an active downlink BWP, the terminal determines a starting time of a physical uplink channel (e.g., a PUCCH or a PUSCH) transmission according to whether the active uplink BWP and the active downlink BWP are the same. For example, when an active uplink BWP and the active downlink BWP of the terminal are the same, the starting time of the physical uplink channel transmission is not related to a predetermined BWP change time; when the active uplink BWP and the active downlink BWP of the terminal are different, the starting time of the physical uplink channel transmission is related to the predetermined BWP change time. In a specific example, when the active uplink BWP and the active downlink BWP of the terminal are the same, the terminal determines a starting time for transmitting the scheduled physical uplink channel (e.g., the PUCCH or the PUSCH) according to a time domain assignment indication in the DCI (e.g., the DCI format); when the active uplink BWP and the active downlink BWP of the terminal are different, the terminal determines the starting time for transmitting the scheduled physical uplink channel (e.g., the PUCCH or the PUSCH) according to the time domain resource assignment indication in the DCI (e.g., the DCI format) and the predetermined BWP change time. For example, if a slot in which the terminal receives the DCI format is slot n (n is the slot index), the terminal may determine to transmit the PUSCH at a slot not earlier than slot n+N, where N=K₂+N_{switch}, where K₂ is an uplink scheduling offset, that is, a minimum interval between the slot in which the DCI (e.g., the DCI format) is received and a starting slot in which the PUSCH is transmitted, and N_{switch} is the predetermined BWP change time.

In example embodiments, when an active uplink BWP and an active downlink BWP of the terminal are different, and the current transmission of the terminal is in the active uplink BWP, the terminal performs a BWP change to the active downlink BWP before receiving a specific downlink signal/channel. For example, the specific downlink signal/channel at least includes one of: an SSB, a PDCCH of a CSS, a PDCCH of a USS, or a SIB. In this way, the downlink reception of key information such as downlink synchronization, system messages and DCI by the terminal can be ensured. In some implementations, in N_{switch} time units before a time unit in which the terminal receives the specific downlink signal/channel, the terminal does not perform an uplink transmission and a downlink reception, where N_{switch} is a predetermined BWP change time, so as to ensure that the terminal changes from the active uplink BWP to the active downlink BWP.

In example embodiments, when the terminal is configured to perform an uplink transmission or a downlink reception in different BWPs in a chronological order, if a time interval between two transmissions (uplink transmission or downlink reception) is less than a predetermined BWP change time, a former transmission (uplink transmission or downlink reception) or a latter transmission (uplink transmission or downlink reception) of the two transmissions is determined to have a higher priority according to the system rules. For example, only one with the higher priority of the two transmissions may be performed, and the other of the two transmissions is considered invalid (for example, the other transmission is not performed or is ignored, for example, information of the other transmission is discarded and/or the information of the other transmission is multiplexed in the transmission with the higher priority). In some implementations, the system rules may be at least one of that: the former transmission of the two transmissions has the higher priority; the latter transmission of the two transmissions has the higher priority; which of the two transmissions has the higher priority is determined according to information or a physical channel corresponding to each transmission. In an example, when a PDSCH and a PDCCH of a CSS are configured on different BWPs, and the time interval is less than the predetermined BWP change time, a priority of the PDCCH may be determined to be higher; and/or when a PUSCH and a PUCCH are configured on different BWPs, and a time interval between the PUSCH transmission and the PUCCH transmission is less than the predetermined BWP change time, a priority of the PUSCH may be determined to be higher, and uplink control information (UCI) carried by the PUCCH is transmitted in the PUSCH.

In example embodiments, when the terminal is required to change between BWP_A and BWP_B, a time required for change between BWP_A and BWP_B (e.g., predetermined BWP change time) may be determined according to capability information related to a multi-BWP operation reported by the terminal. In some implementations, the capability information related to the multi-BWP operation may include at least one of: a capability to support performing an uplink transmission on more than one BWP simultaneously; a capability to support performing a downlink reception on more than one BWP simultaneously; or a capability to support performing an uplink transmission and a downlink reception on different BWPs separately (for example, performing the uplink transmission on a BWP and the downlink reception on another BWP). In some implementations, when the terminal reports that the multi-BWP operation is supported (that is, the terminal supports performing an uplink transmission on more than one BWP simultaneously, and/or performing a downlink reception on more than one BWP simultaneously, and/or performing an uplink transmission and a downlink reception on different BWPs separately), the time required for change between an active uplink BWP and an active downlink BWP may be 0, that is, the change time is not required (or the BWP change is not required).

In example embodiments, there may be an association between BWP configuration parameters for configuring different BWPs. For example, for BWP_A and BWP_B that are different, the association of a BWP configuration parameter of BWP_A with a BWP configuration parameter of BWP_B may be at least one of that: BWP_A and BWP_B have the same subcarrier spacing, BWP_A and BWP_B have the same bandwidth, a bandwidth of BWP_A is adjacent to a bandwidth of BWP_B, and a total bandwidth of BWP_A and BWP_B is not greater than a maximum bandwidth supported by a bandwidth capability of a user. The association of the BWP configuration parameter of BWP_A with the BWP configuration parameter of BWP_B may be pre-specified or predefined by communication specifications, or the association of the BWP configuration parameter of BWP_A with the BWP configuration parameter of BWP_B may be indicated by higher layer signaling. In some implementations, when one of the BWP configuration parameter of BWP_A and the BWP configuration parameter of BWP_B is determined (for example, received from a base station), the terminal may directly determine the other of the BWP configuration parameter of BWP_A and the BWP configuration parameter of BWP_B based on the association of the BWP configuration parameter of BWP_A with the BWP configuration parameter of BWP_B. In this way, a time for the terminal to perform the BWP change may be reduced to a certain extent by associating the BWP configuration parameter of BWP_A with the BWP configuration parameter of BWP_B.

FIGS. 8A and 8B illustrate flowcharts of methods performed by a terminal according to some embodiments of the disclosure.

In the embodiment described in combination with FIGS. 8A and 8B, it is assumed that the terminal has a capability of multi-BWP operation, that is, it may support performing an uplink transmission or a downlink reception on different BWPs simultaneously. In addition, the terminal having the capability of multi-BWP operation may also mean that the terminal does not need extra change time for change between different BWPs, or only needs a short change time, for example, less than one slot.

Referring to FIG. 8A, in operation S810a, the terminal is configured with an active uplink BWP. For example, the terminal may be configured with the active uplink BWP through higher layer signaling (e.g., RRC signaling) or DCI (e.g., a DCI format).

In operation S820a, the terminal performs an uplink transmission on both the configured active uplink BWP and a current active uplink BWP. In particular, for systems with asymmetric spectrum, when the terminal is configured with the active uplink BWP through the higher layer signaling (e.g., RRC signaling) or the DCI (e.g., the DCI format), and the configured active uplink BWP is different from the current active uplink BWP of the terminal, the terminal performs the uplink transmission on the configured active uplink BWP and the current active uplink BWP simultaneously.

In example embodiments, the performing of the uplink transmission on the configured active uplink BWP and the current active uplink BWP simultaneously by the terminal includes at least one of that: the terminal performs the uplink transmission across BWPs on the same time domain symbol; the terminal performs the uplink transmission on different BWPs by means of intra-slot frequency hopping or inter-slot frequency hopping.

By the method according to the embodiment of FIG. 8A, on the basis that the terminal has the capability of multi-BWP operation, the system configuration is optimized to a maximum extent, thereby improving the uplink and downlink transmission quality and the transmission rate of the terminal.

Referring to FIG. 8B, in operation S810b, the terminal is configured with an active downlink BWP. For example, the terminal may be configured with the active downlink BWP through higher layer signaling (e.g., RRC signaling) or DCI (e.g., a DCI format).

In operation S820b, the terminal performs a downlink reception on both the configured active downlink BWP and a current active downlink BWP. In particular, for systems with asymmetric spectrum, when the terminal is configured with the active downlink BWP through the higher-layer signaling (e.g., RRC signaling) or the DCI (e.g., the DCI format), and the configured active downlink BWP is different from the current active downlink BWP of the terminal, the terminal performs the downlink reception on the configured active downlink BWP and the current active downlink BWP simultaneously.

In example embodiments, the performing of the downlink reception on the configured active downlink BWP and the current active downlink BWP simultaneously by the terminal includes one of that: the terminal performs the downlink reception across BWPs on the same time domain symbol; or the terminal performs the downlink reception on different BWPs by means of intra-slot frequency hopping or inter-slot frequency hopping.

By the method according to the embodiment of FIG. 8B, on the basis that the terminal has the capability of multi-BWP operation, the system configuration is optimized to a maximum extent, thereby improving the uplink and downlink transmission quality and the transmission rate of the terminal.

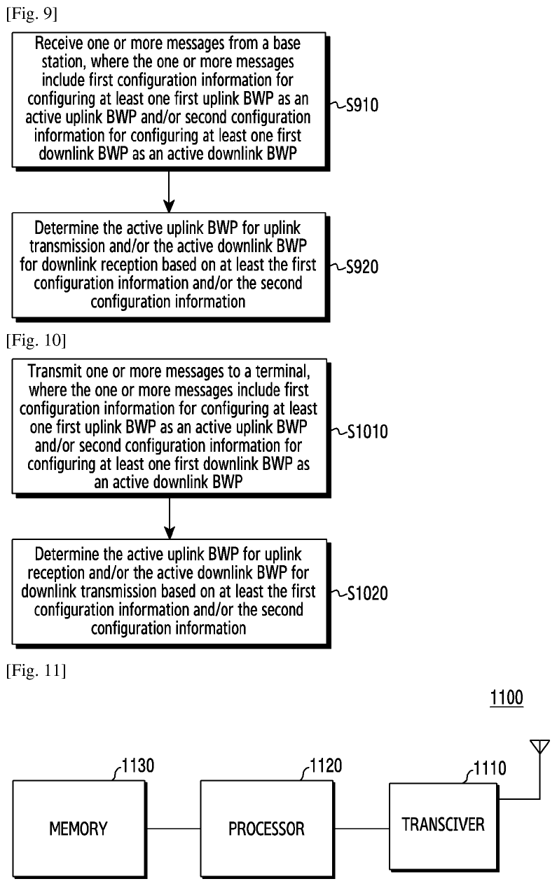

FIG. 9 illustrates a flowchart of a method performed by a terminal according to some embodiments of the disclosure.

Referring to FIG. 9, in operation S910, the terminal receives one or more messages from a base station, where the one or more messages include first configuration information for configuring at least one first uplink bandwidth part (BWP) as an active uplink BWP and/or second configuration information for configuring at least one first downlink BWP as an active downlink BWP.

Next, in operation S920, the terminal determines the active uplink BWP for uplink transmissions and/or the active downlink BWP for downlink receptions based on at least the first configuration information and/or the second configuration information.

In some implementations, for example, operation S920 may include: determining the at least one first uplink BWP as the active uplink BWP for uplink transmissions; and/or determining at least one second downlink BWP that is a current active downlink BWP as the active downlink BWP for downlink receptions. Each of the at least one first uplink BWP is different from each of the second downlink BWP.

In some implementations, for example, operation S920 may include: determining the at least one first downlink BWP as the active downlink BWP for downlink receptions; and/or determining at least one second uplink BWP that is a current active uplink BWP as the active uplink BWP for uplink transmissions. Each of the at least one first downlink BWP is different from each of the at least one second uplink BWP.

In some implementations, for example, operation S920 may include: determining both (i) the at least one first uplink BWP and (ii) at least one second uplink BWP that is a current active uplink BWP (i.e., both (i) and (ii)) as the active uplink BWP for uplink transmissions; and/or determining (iii) the at least one first downlink BWP and (iv) at least one second downlink BWP that is a current active downlink BWP (i.e., both (iii) and (iv)) as the active downlink BWP for downlink receptions.

In some implementations, for example, operation S920 may include: determining one of (i) the at least one first uplink BWP and (ii) at least one second uplink BWP that is a current active uplink BWP (e.g., one of (i) or (ii)) as the active uplink BWP for uplink transmission; and/or determining at least one second downlink BWP that is a current active downlink BWP as the active downlink BWP for downlink receptions. Each of the one of (i) the at least one first uplink BWP and (ii) the at least one second uplink BWP (e.g., one of (i) or (ii)) is different from each of the at least one second downlink BWP. Two different instances of the implementation are described below.

In one instance, for example, operation S920 may include: determining only the at least one first uplink BWP from among the at least one first uplink BWP and at least one second uplink BWP that is a current active uplink BWP as the active uplink BWP for uplink transmissions; and/or determining at least one second downlink BWP that is a current active downlink BWP as the active downlink BWP for downlink receptions. Each of the at least one first uplink BWP is different from each of the at least one second downlink BWP.

In the other instance, for example, operation S920 may include: determining only at least one second uplink BWP that is a current active uplink BWP from among the at least one first uplink BWP and the at least one second uplink BWP as the active uplink BWP for uplink transmissions; and/or determining at least one second downlink BWP that is a current active downlink BWP as the active downlink BWP for downlink receptions. Each of the at least one second uplink BWP is different from each of the at least one second downlink BWP.

In some implementations, for example, operation S920 may include determining one of (iii) the at least one first downlink BWP and (iv) at least one second downlink BWP that is a current active downlink BWP (e.g., one of (iii) or (iv)) as the active downlink BWP for downlink receptions; and/or determining at least one second uplink BWP that is a current active uplink BWP as the active uplink BWP for uplink transmissions. Each of the one of (iii) the at least one first downlink BWP and (iv) the at least one second downlink BWP (e.g., one of (iii) or (iv)) is different from each of the at least one second uplink BWP. Two different instances of the implementation are described below.

In one instance, for example, operation S920 may include: determining only the at least one first downlink BWP from among the at least one first downlink BWP and at least one second downlink BWP that is a current active downlink BWP as the active downlink BWP for downlink receptions; and/or determining at least one second uplink BWP that is a current active uplink BWP as the active uplink BWP for uplink transmissions. Each of the at least one first downlink BWP is different from each of the at least one second uplink BWP.

In the other instance, for example, operation S920 may include: determining only at least one second downlink BWP that is a current active downlink BWP from among the at least one first downlink BWP and the at least one second downlink BWP as the active downlink BWP for downlink receptions; and/or determining at least one second uplink BWP that is the current active uplink BWP as the active uplink BWP for uplink transmissions. Each of the at least one second downlink BWP is different from each of the at least one second uplink BWP.

In some implementations, for example, operation S920 may include: determining one of (i) the at least one first uplink BWP and (ii) at least one second uplink BWP that is a current active uplink BWP (e.g., one of (i) and (ii)) to be used to transmit a first uplink signal, and determining the other of (i) the at least one first uplink BWP and (ii) the at least one second uplink BWP (e.g., the other of (i) and (ii)) to be used to transmit a second uplink signal which is different from the first uplink signal. A time for transmitting the first uplink signal is different from a time for transmitting the second uplink signal. An instance of the implementations is described below.

In the instance, for example, operation S920 may include: determining only the at least one first uplink BWP from among the at least one first uplink BWP and at least one second uplink BWP that is a current active uplink BWP to be used to transmit a first uplink signal, and determining only the at least one second uplink BWP from among the at least one first uplink BWP and the at least one second uplink BWP to be used to transmit a second uplink signal different from the first uplink signal. A time for transmitting the first uplink signal is different from a time for transmitting the second uplink signal.

In some implementations, for example, each of the first uplink signal and the second uplink signal may include one of: a Physical Uplink Shared Channel (PUSCH), a Physical Uplink Control Channel (PUCCH), or a Physical Random Access Channel (PRACH).

In some implementations, for example, operation S920 may include: determining one of (iii) the at least one first downlink BWP and (iv) at least one second downlink BWP that is a current active downlink BWP (i.e., one of (iii) and (iv)) to be used to receive a first downlink signal, and determining the other of (iii) the at least one first downlink BWP and (iv) the at least one second downlink BWP (e.g., the other of (iii) and (iv)) to be used to receive a second downlink signal which is different from the first downlink signal. A time for receiving the first downlink signal is different from a time for receiving the second downlink signal. An instance of the implementations will be described below.

In the instance, for example, operation S920 may include: determining only the at least one first downlink BWP from among the at least one first downlink BWP and at least one second downlink BWP that is a current active downlink BWP to be used to receive a first downlink signal, and determining only the at least one second downlink BWP from among the at least one first downlink BWP and the at least one second downlink BWP to be used to receive a second downlink signal which is different from the first downlink signal. A time for receiving the first downlink signal is different from a time for receiving the second downlink signal.

In some implementations, for example, each of the first downlink signal and the second downlink signal may include one of: a Physical Downlink Shared Channel (PDSCH), a Physical Downlink Control Channel (PDCCH) of a Common Search Space (CSS), a PDCCH of a UE-specific Search Space (USS), a synchronization signal and a physical broadcast channel block (SSB), or a system message block.

In some implementations, when the downlink reception is performed in the active downlink BWP, whether a time for an uplink transmission corresponding to the downlink reception is related to a predetermined time for a BWP change may be determined based on whether the active uplink BWP is the same as the active downlink BWP.

In some implementations, when a Physical Downlink Shared Channel (PDSCH) is received in the active downlink BWP, a time for feeding back Hybrid Automatic Repeat Request (HARQ) information of the PDSCH may be determined based on whether the active uplink BWP is the same as the active downlink BWP. For example, whether the time for feeding back the HARQ information of the PDSCH is related to the predetermined time for the BWP change may be determined based on whether the active uplink BWP is the same as the active downlink BWP.

In some implementations, the time for the uplink transmission may be determined based on whether the active uplink BWP is the same as the active downlink BWP, when a Physical Downlink Control Channel (PDCCH) is received in the active downlink BWP. For example, whether the time for the uplink transmission is related to the predetermined time for the BWP change may be determined based on whether the active uplink BWP is the same as the active downlink BWP.

In some implementations, for example, a BWP change to the active downlink BWP may be performed before a downlink reception is performed, when the active uplink BWP is different from the active downlink BWP and an uplink transmission is currently performed in the active uplink BWP.

In some implementations, for example, an uplink transmission and a downlink reception may not be performed within the predetermined time for the BWP change.

In some implementations, for example, the predetermined time for the BWP change may be determined based on a capability of the terminal. The capability of the terminal may include at least one of: a capability to support performing an uplink transmission on more than one BWP simultaneously; a capability to support performing a downlink reception on more than one BWP simultaneously; or a capability to support performing an uplink transmission and a downlink reception on different BWPs separately.

FIG. 10 illustrates a flowchart of a method performed by a base station according to some embodiments of the disclosure.

Referring to FIG. 10, in operation S1010, the base station transmits one or more messages to a terminal, where the one or more messages include first configuration information for configuring at least one first uplink bandwidth part (BWP) as an active uplink BWP and/or second configuration information for configuring at least one first downlink BWP as an active downlink BWP.

In operation S1020, the base station determines the active uplink BWP for uplink receptions and/or the active downlink BWP for downlink transmissions based on at least the first configuration information and/or the second configuration information.

In some implementations, for example, operation S1020 may include: determining the at least one first uplink BWP as the active uplink BWP for uplink receptions; and/or determining at least one second downlink BWP that is a current active downlink BWP as the active downlink BWP for downlink transmissions. Each of the at least one first uplink BWP is different from each of the second downlink BWP.

In some implementations, for example, operation S1020 may include: determining the at least one first downlink BWP as the active downlink BWP for downlink transmissions; and/or determining at least one second uplink BWP that is a current active uplink BWP as the active uplink BWP for uplink receptions. Each of the at least one first downlink BWP is different from each of the at least one second uplink BWP.

In some implementations, for example, operation S1020 may include: determining both (i) the at least one first uplink BWP and (ii) at least one second uplink BWP that is a current active uplink BWP (i.e., both (i) and (ii)) as the active uplink BWP for uplink receptions; and/or determining all of the at least one first downlink BWP and at least one second downlink BWP that is a current active downlink BWP as the active downlink BWP for downlink transmissions.

In some implementations, for example, operation S1020 may include: determining one of (i) the at least one first uplink BWP and (ii) at least one second uplink BWP that is a current active uplink BWP (i.e., one of (i) and (ii)) as the active uplink BWP for uplink receptions; and/or determining at least one second downlink BWP that is a current active downlink BWP as the active downlink BWP for downlink transmissions. Each of the at least one first uplink BWP is different from each of the at least one second downlink BWP. Some instances of the implementations are described below.

In an instance, for example, operation S1020 may include: determining only the at least one first uplink BWP from among the at least one first uplink BWP and at least one second uplink BWP that is a current active uplink BWP as the active uplink BWP for uplink receptions; and/or determining at least one second downlink BWP that is a current active downlink BWP as the active downlink BWP for downlink transmissions. Each of the at least one first uplink BWP is different from each of the at least one second downlink BWP.

In another instance, for example, operation S1020 may include: determining only at least one second uplink BWP that is a current active uplink BWP from among the at least one first uplink BWP and the at least one second uplink BWP as the active uplink BWP for uplink receptions; and/or determining at least one second downlink BWP that is a current active downlink BWP as the active downlink BWP for downlink transmissions. Each of the at least one second uplink BWP is different from each of the at least one second downlink BWP.

In some implementations, for example, operation S1020 may include: determining one of (iii) the at least one first downlink BWP and (iv) at least one second downlink BWP that is a current active downlink BWP (i.e., one of (iii) and (iv)) as the active downlink BWP for downlink transmissions; and/or determining at least one second uplink BWP that is a current active uplink BWP as the active uplink BWP for uplink receptions. Each of the at least one first downlink BWP is different from each of the at least one second uplink BWP. Some instances of the implementation are described below.

In an instance, for example, operation S1020 may include: determining only the at least one first downlink BWP from among the at least one first downlink BWP and at least one second downlink BWP that is a current active downlink BWP as the active downlink BWP for downlink transmissions; and/or determining at least one second uplink BWP that is a current active uplink BWP as the active uplink BWP for uplink receptions. Each of the at least one first downlink BWP is different from each of the at least one second uplink BWP.

In another instance, for example, operation S1020 may include: determining only at least one second downlink BWP that is a current active downlink BWP from among the at least one first downlink BWP and the at least one second downlink BWP as the active downlink BWP for downlink transmissions; and/or determining at least one second uplink BWP that is a current active uplink BWP as the active uplink BWP for uplink receptions. Each of the at least one second downlink BWP is different from each of the at least one second uplink BWP.

In some implementations, for example, operation S1020 may include: determining one of (i) the at least one first uplink BWP and (ii) at least one second uplink BWP that is a current active uplink BWP (i.e., one of (i) and (ii)) to be used to receive a first uplink signal, and determining the other of (i) the at least one first uplink BWP and (ii) the at least one second uplink BWP to be used to receive a second uplink signal different from the first uplink signal. A time for receiving the first uplink signal may be different from a time for receiving the second uplink signal. An instance of the implementations is described below.

In the instance, for example, operation S1020 may include: determining only the at least one first uplink BWP from among the at least one first uplink BWP and at least one second uplink BWP that is a current active uplink BWP to be used to receive a first uplink signal, and determining only the at least one second uplink BWP from among the at least one first uplink BWP and the at least one second uplink BWP to be used to receive a second uplink signal which is different from the first uplink signal. A time for receiving the first uplink signal may be different from a time for receiving the second uplink signal.

In some implementations, for example, each of the first uplink signal and the second uplink signal includes one of: a Physical Uplink Shared Channel (PUSCH), a Physical Uplink Control Channel (PUCCH), or a Physical Random Access Channel (PRACH).

In some implementations, for example, operation S1020 may include: determining one of (iii) the at least one first downlink BWP and (iv) at least one second downlink BWP that is a current active downlink BWP (i.e., one of (iii) and (iv)) to be used to transmit a first downlink signal, and determining the other of (iii) the at least one first downlink BWP and (iv) the at least one second downlink BWP (i.e., the other of (iii) and (iv)) to be used to transmit a second downlink signal which is different from the first downlink signal. A time for transmitting the first downlink signal is different from a time for transmitting the second downlink signal. An instance of the implementations is described below.

In the instance, for example, operation S1020 may include: determining only the at least one first downlink BWP from among the at least one first downlink BWP and at least one second downlink BWP that is a current active downlink BWP to be used to transmit a first downlink signal, and determining only the at least one second downlink BWP from among the at least one first downlink BWP and the at least one second downlink BWP to be used to transmit a second downlink signal which is different from the first downlink signal. A time for transmitting the first downlink signal is different from a time for transmitting the second downlink signal.

In some implementations, for example, each of the first downlink signal and the second downlink signal includes one of: a Physical Downlink Shared Channel (PDSCH), a Physical Downlink Control Channel (PDCCH) of a Common Search Space (CSS), a PDCCH of a UE-specific Search Space (USS), a synchronization signal and physical broadcast channel block (SSB), or a system message block.

In some implementations, the method further includes: determining, when a downlink transmission is performed in the active downlink BWP, whether a time for an uplink reception corresponding to the downlink transmission is related to a predetermined time for a BWP change based on whether the active uplink BWP is the same as the active downlink BWP.

In some implementations, for example, when the downlink reception is for a Physical Downlink Shared Channel (PDSCH), the uplink transmission corresponding to the downlink reception is used to feed back Hybrid Automatic Repeat Request (HARQ) information of the PDSCH.

In some implementations, for example, when the received downlink reception is for a Physical Downlink Control Channel (PDCCH), the uplink transmission corresponding to the downlink reception is for a physical channel (e.g., PUCCH or PUSCH) scheduled by the PDCCH.

In some implementations, for example, when a Physical Downlink Shared Channel (PDSCH) is transmitted in the active downlink BWP, a time for receiving Hybrid Automatic Repeat Request (HARQ) information of the PDSCH is determined based on whether the active uplink BWP is the same as the active downlink BWP. For example, whether the time for receiving the HARQ information of the PDSCH is related to a predetermined time for a BWP change may be determined based on whether the active uplink BWP is the same as the active downlink BWP.

In some implementations, the method further includes: determining, when a Physical Downlink Control Channel (PDCCH) is transmitted in the active downlink BWP, a time for an uplink reception based on whether the active uplink BWP is the same as the active downlink BWP. For example, whether the time for the uplink reception is related to the predetermined time for the BWP change may be determined based on whether the active uplink BWP is the same as the active downlink BWP.

In some implementations, for example, a BWP change to the active downlink BWP is performed before a downlink transmission is performed, when the active uplink BWP is different from the active downlink BWP and an uplink reception is currently performed in the active uplink BWP.

In some implementations, for example, an uplink reception and a downlink transmission are not performed within the predetermined time for the BWP change; and/or an uplink transmission and a downlink reception of the terminal and/or other terminals within the predetermined time for the BWP change are not configured; and/or the terminal and/or other terminals are configured such that an uplink transmission and a downlink reception are not performed within the predetermined time for the BWP change.

In some implementations, for example, the predetermined time for the BWP change is determined based on a capability of the terminal reported by the terminal. The capability of the terminal includes at least one of: a capability to support performing an uplink transmission on more than one BWP simultaneously; a capability to support performing a downlink reception on more than one BWP simultaneously; or a capability to support performing an uplink transmission and a downlink reception on different BWPs separately.

FIG. 11 illustrates a block diagram of a configuration of a terminal according to some embodiments of the disclosure.

Referring to FIG. 11, a terminal 1100 according to embodiments of the disclosure may include a transceiver 1110, at least one processor 1120 and a memory 1130. The terminal may be implemented to include a larger or smaller number of elements than those shown in FIG. 11.

The transceiver 1110 may transmit or receive signals to or from another terminal, a base station and/or a network entity. For example, the transceiver 1110 may receive, for example, a downlink signal/channel from the base station and may transmit an uplink signal/channel to the base station.

The processor 1120 may control overall operations of the terminal. For example, the processor 1120 may control the transceiver 1110 and the memory 1130 to: determine an active uplink BWP and transmit the uplink signal/channel on the determined active uplink BWP; and/or determine an active downlink BWP and receive the downlink signal/channel on the determined active downlink BWP.

In example embodiments, the processor 1120 may be configured to perform one or more of the operations in various embodiments described above.

In example embodiments, for example, the uplink signal/channel may include at least one of: a PUSCH, a PUCCH (or UCI carried by it), a PRACH, a Demodulation Reference Signal (DMRS) of a PUSCH, a DMRS of a PUCCH, a Sounding Reference Signal (SRS), or a Phase Tracking Reference Signal (PT-RS).

In example embodiments, for example, the downlink signal/channel may include at least one of: a PBCH, a PDSCH, or a PDCCH (or DCI carried by it), a DMRS, a PT-RS, a Channel State Information Reference Signal (CSI-RS), a PSS, or an SSS.

The memory 1130 may store information, data, programs, instructions, etc., processed by the terminal.

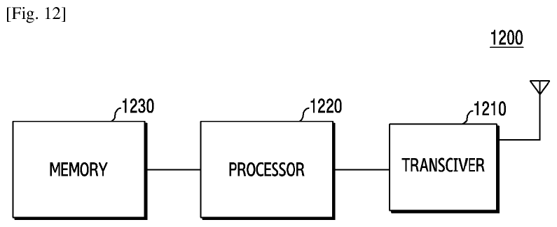

FIG. 12 illustrates a block diagram of a configuration of a base station according to some embodiments of the disclosure.

Referring to FIG. 12, a base station 1200 according to the above embodiments may include a transceiver 1210, at least one base station processor 1220 and a memory 1230. The base station may be implemented to include a larger or smaller number of elements than those shown in FIG. 12.

The transceiver 1210 may transmit or receive signals to or from a terminal, another base station and/or a network entity. For example, the transceiver 1210 may transmit, for example, a downlink signal/channel to the terminal and may receive an uplink signal/channel from the terminal.

The processor 1220 may control overall operations of the terminal. For example, the processor 1220 may control the transceiver 1210 and the memory 1230 to: determine an active uplink BWP and transmit the uplink signal/channel on the determined active uplink BWP; and/or determine an active downlink BWP and receive the downlink signal/channel on the determined active downlink BWP.

The processor 1220 may control overall operations of the base station. For example, the processor 1220 may control the transceiver 1210 and the memory 1230 to: determine an active uplink BWP and receive the uplink signal/channel on the determined active uplink BWP; and/or determine an active downlink BWP and transmit the downlink signal/channel on the determined active downlink BWP.

In example embodiments, the processor 1220 may be configured to perform one or more of the operations in various embodiments described above.

In example embodiments, for example, the uplink signal/channel may include at least one of: a PUSCH, a PUCCH (or UCI carried by it), a PRACH, a DMRS of a PUSCH, a DMRS of a PUCCH, a SRS, or a PT-RS.

In example embodiments, for example, the downlink signal/channel may include at least one of: a PBCH, a PDSCH, or a PDCCH (or DCI carried by it), a DMRS, a PT-RS, a CSI-RS, a PSS, or an SSS.

The memory 1230 may store information, data, programs, instructions, etc., processed by the base station.

In one embodiment, a method performed by a terminal in a wireless communication system is provided. The method includes receiving one or more messages from a base station, wherein the one or more messages include first configuration information for configuring at least one first uplink bandwidth part (BWP) as an active uplink BWP and/or second configuration information for configuring at least one first downlink BWP as an active downlink BWP; and determining the active uplink BWP for an uplink transmission and/or the active downlink BWP for a downlink reception based on at least the first configuration information and/or the second configuration information.

In one embodiment, wherein the determining of the active uplink BWP for the uplink transmission and/or the active downlink BWP for the downlink reception includes determining the at least one first uplink BWP as the active uplink BWP for the uplink transmission; and/or determining at least one second downlink BWP that is a current active downlink BWP as the active downlink BWP for the downlink reception, wherein each of the at least one first uplink BWP is different from each of the second downlink BWP.

In one embodiment, wherein the determining of the active uplink BWP for the uplink transmission and/or the active downlink BWP for the downlink reception includes determining the at least one first downlink BWP as the active downlink BWP for the downlink reception; and/or determining at least one second uplink BWP that is a current active uplink BWP as the active uplink BWP for the uplink transmission, wherein each of the at least one first downlink BWP is different from each of the at least one second uplink BWP.

In one embodiment, wherein the determining of the active uplink BWP for the uplink transmission and/or the active downlink BWP for the downlink reception includes determining all of the at least one first uplink BWP and at least one second uplink BWP that is a current active uplink BWP as the active uplink BWP for the uplink transmission; and/or determining all of the at least one first downlink BWP and at least one second downlink BWP that is a current active downlink BWP as the active downlink BWP for the downlink reception.

In one embodiment, wherein the determining of the active uplink BWP for the uplink transmission and/or the active downlink BWP for the downlink reception includes determining only the at least one first uplink BWP from among the at least one first uplink BWP and at least one second uplink BWP that is a current active uplink BWP as the active uplink BWP for the uplink transmission; and/or determining at least one second downlink BWP that is a current active downlink BWP as the active downlink BWP for the downlink reception, wherein each of the at least one first uplink BWP is different from each of the at least one second downlink BWP.

In one embodiment, wherein the determining of the active uplink BWP for the uplink transmission and/or the active downlink BWP for the downlink reception includes determining only at least one second uplink BWP that is a current active uplink BWP from among the at least one first uplink BWP and the at least one second uplink BWP as the active uplink BWP for the uplink transmission; and/or determining at least one second downlink BWP that is a current active downlink BWP as the active downlink BWP for the downlink reception, wherein each of the at least one second uplink BWP is different from each of the at least one second downlink BWP.

In one embodiment, wherein the determining of the active uplink BWP for the uplink transmission and/or the active downlink BWP for the downlink reception includes determining only the at least one first downlink BWP from among the at least one first downlink BWP and at least one second downlink BWP that is a current active downlink BWP as the active downlink BWP for the downlink reception; and/or determining at least one second uplink BWP that is a current active uplink BWP as the active uplink BWP for the uplink transmission, wherein each of the at least one first downlink BWP is different from each of the at least one second uplink BWP.

In one embodiment, wherein the determining of the active uplink BWP for the uplink transmission and/or the active downlink BWP for the downlink reception includes determining only at least one second downlink BWP that is a current active downlink BWP from among the at least one first downlink BWP and the at least one second downlink BWP as the active downlink BWP for the downlink reception; and/or determining at least one second uplink BWP that is a current active uplink BWP as the active uplink BWP for the uplink transmission, wherein each of the at least one second downlink BWP is different from each of the at least one second uplink BWP.

In one embodiment, wherein the determining of the active uplink BWP for the uplink transmission and/or the active downlink BWP for the downlink reception includes determining only the at least one first uplink BWP from among the at least one first uplink BWP and at least one second uplink BWP that is a current active uplink BWP to be used to transmit a first uplink signal, and determining only the at least one second uplink BWP from among the at least one first uplink BWP and the at least one second uplink BWP to be used to transmit a second uplink signal which is different from the first uplink signal, wherein a time for transmitting the first uplink signal is different from a time for transmitting the second uplink signal.

In one embodiment, wherein the determining of the active uplink BWP for the uplink transmission and/or the active downlink BWP for the downlink reception includes determining only the at least one first downlink BWP from among the at least one first downlink BWP and at least one second downlink BWP that is a current active downlink BWP to be used to receive a first downlink signal, and determining only the at least one second downlink BWP from among the at least one first downlink BWP and the at least one second downlink BWP to be used to receive a second downlink signal which is different from the first downlink signal, wherein a time for receiving the first downlink signal is different from a time for receiving the second downlink signal.

In one embodiment, further including determining, when downlink reception is performed in the active downlink BWP, whether a time for the uplink transmission corresponding to the downlink reception is related to a predetermined time for a BWP change based on whether the active uplink BWP is the same as the active downlink BWP.

In one embodiment, wherein, when the downlink reception is for a Physical Downlink Shared Channel (PDSCH), the uplink transmission corresponding to the downlink reception is used to feed back Hybrid Automatic Repeat Request (HARQ) information of the PDSCH, wherein, when the received downlink reception is for a Physical Downlink Control Channel (PDCCH), the uplink transmission corresponding to the downlink reception is scheduled by the PDCCH.

In one embodiment, wherein a BWP change to the active downlink BWP is performed before the downlink reception is performed, when the active uplink BWP is different from the active downlink BWP and the uplink transmission is currently performed in the active uplink BWP.

In one embodiment, wherein the uplink transmission and the downlink reception are not performed within the predetermined time for the BWP change.

In one embodiment, wherein the predetermined time for the BWP change is determined based on a capability of the terminal, wherein the capability of the terminal includes at least one of: a capability to support performing the uplink transmission on more than one BWP simultaneously; a capability to support performing the downlink reception on more than one BWP simultaneously; or a capability to support performing the uplink transmission and the downlink reception on different BWPs separately.

In one embodiment, a method performed by a base station in a wireless communication system is provided. The method includes transmitting one or more messages to a terminal, wherein the one or more messages include first configuration information for configuring at least one first uplink bandwidth part (BWP) as an active uplink BWP and/or second configuration information for configuring at least one first downlink BWP as an active downlink BWP; and determining the active uplink BWP for an uplink reception and/or the active downlink BWP for a downlink transmission based on at least the first configuration information and/or the second configuration information.

In one embodiment, a terminal in a wireless communication system is provided. The terminal includes a transceiver configured to transmit and receive signals; and a controller coupled with the transceiver and configured to receive one or more messages from a base station, wherein the one or more messages include first configuration information for configuring at least one first uplink bandwidth part (BWP) as an active uplink BWP and/or second configuration information for configuring at least one first downlink BWP as an active downlink BWP; and determine the active uplink BWP for an uplink transmission and/or the active downlink BWP for a downlink reception based on at least the first configuration information and/or the second configuration information.

In one embodiment, a base station in a wireless communication system is provided. The base station includes a transceiver configured to transmit and receive signals; and a controller coupled with the transceiver and configured to transmit one or more messages to a terminal, wherein the one or more messages include first configuration information for configuring at least one first uplink bandwidth part (BWP) as an active uplink BWP and/or second configuration information for configuring at least one first downlink BWP as an active downlink BWP; and determine the active uplink BWP for an uplink reception and/or the active downlink BWP for a downlink transmission based on at least the first configuration information and/or the second configuration information.

According to embodiments of the disclosure, at least a part of an apparatus (e.g., a module or its function) or a method (e.g., an operation or a step) may be implemented as instructions stored in a computer-readable storage medium (e.g., a memory) in the form of program modules, for example. When executed by a processor or controller, the instructions may enable the processor or controller to perform corresponding functions. Computer-readable media may include, for example, hard disk, floppy disk, magnetic media, optical recording media, DVD, magneto-optical media. The instructions may include codes created by a compiler or codes executable by an interpreter. The modules or apparatuses according to various embodiments of the disclosure may include at least one or more of the above components, omit some of them, or include other additional components. The operations performed by the modules, programming modules or other components according to various embodiments of the disclosure may be performed sequentially, concurrently, repeatedly or heuristically, or at least some operations may be performed in a different order or omitted, or other operations may be added.

The above descriptions are only exemplary implementations of the present invention, and are not used to limit the scope of protection of the present invention, which is determined by the appended claims.

1-15. (canceled)

16. A method performed by a terminal in a wireless communication system, the method comprising:
receiving, from a base station, first configuration information for configuring a first bandwidth part (BWP) for an active uplink (UL) BWP and second configuration information for configuring a second BWP for an active downlink (DL) BWP; and
performing UL transmission to the base station and DL reception from the base station based on whether the first BWP for the active UL BWP is same with the second BWP for the active DL BWP,
wherein in case that the first BWP is different from the second BWP, the UL transmission is performed on the first BWP and the DL reception is performed on the second BWP, separately based on a change of an association between the UL active BWP and the DL active BWP.

17. The method of claim 16, wherein the DL reception is reception of a physical downlink shared channel (PDSCH) on the DL BWP and the UL transmission is transmission of hybrid automatic repeat request (HARQ) information for the PDSCH on the UL BWP, and
wherein in case that the first BWP is different from the second BWP, a time at which the transmission of the HARQ information is performed is identified based on a predetermined BWP change time associated with the change of the association between the UL active BWP and the DL active BWP.

18. The method of claim 17, wherein the DL reception is reception of a physical downlink control channel (PDCCH) for a physical uplink channel on the DL BWP and the UL transmission is transmission of the physical uplink channel on the UL BWP, and
wherein in case that the first BWP is different from the second BWP, a time at which the transmission of the physical uplink channel is performed is identified based on a predetermined BWP change time associated with the change of the association between the UL active BWP and the DL active BWP.

19. The method of claim 18, wherein the predetermined BWP change time is identified based on a capability of the terminal associated with multi-BWP operation, and
wherein the multi-BWP operation includes at least one of an operation performing the UL transmission on more than one UL BWP simultaneously, an operation performing the DL reception on more than one BWP simultaneously, or an operation performing the UL transmission and the DL reception on different BWPs separately.

20. A method performed by a base station in a wireless communication system, the method comprising:
transmitting, to a terminal, first configuration information for configuring a first bandwidth part (BWP) for an active uplink (UL) BWP and second configuration information for configuring a second BWP for an active downlink (DL) BWP; and
performing UL reception from the terminal and DL transmission to the terminal based on whether the first BWP for the active UL BWP is same with the second BWP for the active DL BWP,
wherein in case that the first BWP is different from the second BWP, the UL reception is performed on the first BWP and the DL transmission is performed on the second BWP, separately based on a change of an association between the UL active BWP and the DL active BWP.

21. The method of claim 20, wherein the DL transmission is transmission of a physical downlink shared channel (PDSCH) on the DL BWP and the UL reception is reception of hybrid automatic repeat request (HARQ) information for the PDSCH on the UL BWP, and
wherein in case that the first BWP is different from the second BWP, a time at which the reception of the HARQ information is performed is identified based on a predetermined BWP change time associated with the change of the association between the UL active BWP and the DL active BWP.

22. The method of claim 21, wherein the DL transmission is transmission of a physical downlink control channel (PDCCH) for a physical uplink channel on the DL BWP and the UL reception is reception of the physical uplink channel on the UL BWP, and
wherein in case that the first BWP is different from the second BWP, a time at which the reception of the physical uplink channel is performed is identified based on a predetermined BWP change time associated with the change of the association between the UL active BWP and the DL active BWP.

23. The method of claim 22, wherein the predetermined BWP change time is identified based on a capability of the terminal associated with multi-BWP operation, and
wherein the multi-BWP operation includes at least one of an operation performing the UL transmission on more than one UL BWP simultaneously, an operation performing the DL reception on more than one BWP simultaneously, or an operation performing the UL transmission and the DL reception on different BWPs separately.

24. A terminal in a wireless communication system, the terminal comprising:
a transceiver; and
a controller coupled with the transceiver and configured to:
receive, from a base station, first configuration information for configuring a first bandwidth part (BWP) for an active uplink (UL) BWP and second configuration information for configuring a second BWP for an active downlink (DL) BWP; and
perform UL transmission to the base station and DL reception from the base station based on whether the first BWP for the active UL BWP is same with the second BWP for the active DL BWP,
wherein in case that the first BWP is different from the second BWP, the UL transmission is performed on the first BWP and the DL reception is performed on the second BWP, separately based on a change of an association between the UL active BWP and the DL active BWP.

25. The terminal of claim 24, wherein the DL reception is reception of a physical downlink shared channel (PDSCH) on the DL BWP and the UL transmission is transmission of hybrid automatic repeat request (HARQ) information for the PDSCH on the UL BWP, and
wherein in case that the first BWP is different from the second BWP, a time at which the transmission of the HARQ information is performed is identified based on a predetermined BWP change time associated with the change of the association between the UL active BWP and the DL active BWP.

26. The terminal of claim 25, wherein the DL reception is reception of a physical downlink control channel (PDCCH) for a physical uplink channel on the DL BWP and the UL transmission is transmission of the physical uplink channel on the UL BWP, and
wherein in case that the first BWP is different from the second BWP, a time at which the transmission of the physical uplink channel is performed is identified based on a predetermined BWP change time associated with the change of the association between the UL active BWP and the DL active BWP.

27. The terminal of claim 26, wherein the predetermined BWP change time is identified based on a capability of the terminal associated with multi-BWP operation, and
wherein the multi-BWP operation includes at least one of an operation performing the UL transmission on more than one UL BWP simultaneously, an operation performing the DL reception on more than one BWP simultaneously, or an operation performing the UL transmission and the DL reception on different BWPs separately.

28. A base station in a wireless communication system, the base station comprising:
a transceiver; and
a controller coupled with the transceiver and configured to:
transmit, to a terminal, first configuration information for configuring a first bandwidth part (BWP) for an active uplink (UL) BWP and second configuration information for configuring a second BWP for an active downlink (DL) BWP; and
perform UL reception from the terminal and DL transmission to the terminal based on whether the first BWP for the active UL BWP is same with the second BWP for the active DL BWP,
wherein in case that the first BWP is different from the second BWP, the UL reception is performed on the first BWP and the DL transmission is performed on the second BWP, separately based on a change of an association between the UL active BWP and the DL active BWP.

29. The base station of claim 28, wherein the DL transmission is transmission of a physical downlink shared channel (PDSCH) on the DL BWP and the UL reception is reception of hybrid automatic repeat request (HARQ) information for the PDSCH on the UL BWP, and
wherein in case that the first BWP is different from the second BWP, a time at which the reception of the HARQ information is performed is identified based on a predetermined BWP change time associated with the change of the association between the UL active BWP and the DL active BWP.

30. The base station of claim 29, wherein the DL transmission is transmission of a physical downlink control channel (PDCCH) for a physical uplink channel on the DL BWP and the UL reception is reception of the physical uplink channel on the UL BWP, and
wherein in case that the first BWP is different from the second BWP, a time at which the reception of the physical uplink channel is performed is identified based on a predetermined BWP change time associated with the change of the association between the UL active BWP and the DL active BWP.

31. The base station of claim 29, wherein the DL transmission is transmission of a physical downlink control channel (PDCCH) for a physical uplink channel on the DL BWP and the UL reception is reception of the physical uplink channel on the UL BWP, and
wherein in case that the first BWP is different from the second BWP, a time at which the reception of the physical uplink channel is performed is identified based on a predetermined BWP change time associated with the change of the association between the UL active BWP and the DL active BWP.
